(19) United States
(12) Patent Application Publication
(10) Pub. No.: US 2010/0241460 A1
(43) Pub. Date: Sep. 23, 2010

(54) Loss Mitigation

(75) Inventor: Sean Oliver Woodward, Canton, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: GENERAL ROYALTY CAPITAL COMPANY, Atlanta, GA (US)

(21) Appl. No.: 12/724,960

(22) Filed: Mar. 16, 2010

Related U.S. Application Data
(60) Provisional application No. 61/210,381, filed on Mar. 18, 2009.

(51) Int. Cl. G06Q 40/00; G06Q 50/00; G06N 5/02; G06Q 20/00

(52) U.S. Cl. 705/4; 706/52

(57) ABSTRACT

Included are embodiments for providing a loss mitigation instrument. At least one embodiment of a method includes providing, by a computing device, an interface for a party to a lease of property to apply for a loss mitigation instrument; receiving, by the computing device, information from the party to the lease regarding the lessee and the property; determining, by the computing device, terms for the loss mitigation instrument based on the received information, where the loss mitigation instrument is configured to provide for payment on a claim for default on a lease by the lessee, where the default results from a predetermined cause to the lessee; and providing, by the computing device, the loss mitigation instrument to the party to the lease.

### CROSS REFERENCE

This application claims priority to copending U.S. provisional application entitled, “Method for Underwriting and Insuring a Real Property Lease Agreement,” having U.S. Ser. No. 61/210,381, filed Mar. 18, 2009, which is entirely incorporated herein by reference.

This application is also related to U.S. application Ser. No. xx/yyy,yyy, entitled Loss Mitigation Analysis (Attorney Docket Number 190720-1020) and U.S. application Ser. No. xx/yyy,yyy, entitled Loss Mitigation Fulfillment (Attorney Docket Number 190720-1030), both of which were filed on the same day as this application and both of which are incorporated by reference in their entireties.

### BACKGROUND

As is common, people often desire to rent or lease property, instead of purchasing the property themselves. Depending on the type of property, the dollar amount of the lease, and/or other factors, renters (lessees) may desire to pay the entire lease amount up front or they may desire to finance the lease payment over the length of the lease (or other term). As the most common option is often to finance the lease payments over the term of the lease, lessors are often put at risk regarding a lessee's obligation to fully comply with the lease agreement and payment terms.

Accordingly, in many current solutions, a lessor may perform a credit check, employment check, and/or a reference check to determine whether a potential lessee can fulfill the monthly obligation for leasing the property. While such background checks can reduce the likelihood of the lessee defaulting on the lease, oftentimes an unexpected situation develops that prevents an otherwise trustworthy lessee from fulfilling the lease agreement.

### SUMMARY

Included are embodiments for providing a loss mitigation instrument. At least one embodiment of a method includes providing, by a computing device, an interface for a party to a lease of property to apply for a loss mitigation instrument; receiving, by the computing device, information from the party to the lease regarding the lessee and the property; determining, by the computing device, terms for the loss mitigation instrument based on the received information, where the loss mitigation instrument is configured to provide for payment of a claim for default on a lease by the lessee, where the default results from a predetermined cause to the lessee; and providing, by the computing device, the loss mitigation instrument to the party to the lease.

Also included herein are embodiments of a system. At least one embodiment of a system includes a memory component that stores risk assessment logic that includes instructions for performing at least the following: providing, by a computing device, an interface for a party to a lease of property to apply for a loss mitigation instrument; receiving, by the computing device, information from the party to the lease regarding the lessee and the property; determining, by the computing device, terms for the loss mitigation instrument based on the received information, where the loss mitigation instrument is configured to provide for payment of a claim for default on a lease by the lessee, where the default results from a predetermined cause to the lessee; and providing, by the computing device, the loss mitigation instrument to the party to the lease.

Also included are embodiments of a computer-readable medium that stores a program for performing the following: providing, by a computing device, an interface for a party to a lease of property to apply for a loss mitigation instrument; receiving, by the computing device, information from the party to the lease regarding the lessee and the property; determining, by the computing device, terms for the loss mitigation instrument based on the received information, where the loss mitigation instrument is configured to provide for payment of a claim for default on a lease by the lessee, where the default results from a predetermined unexpected financial hardship to the lessee, as defined in the loss mitigation instrument; and providing, by the computing device, the loss mitigation instrument to the lessee.

Other embodiments and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

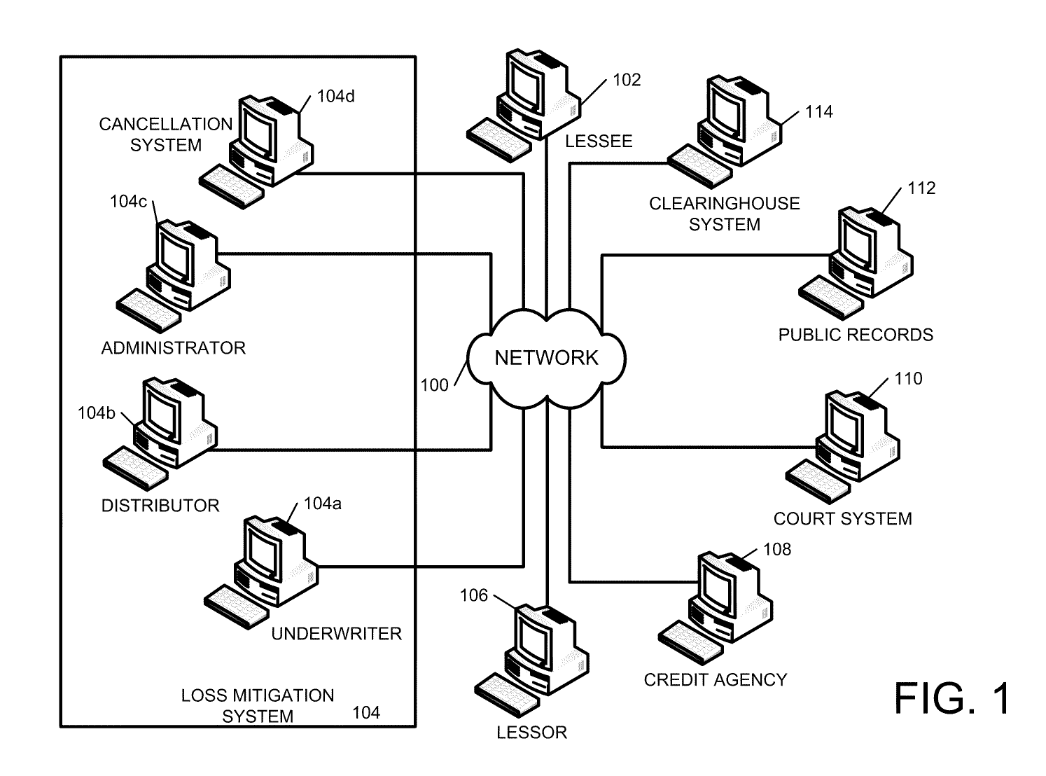

FIG. 1 illustrates a nonlimiting example of a computing environment for providing a loss mitigation instrument.

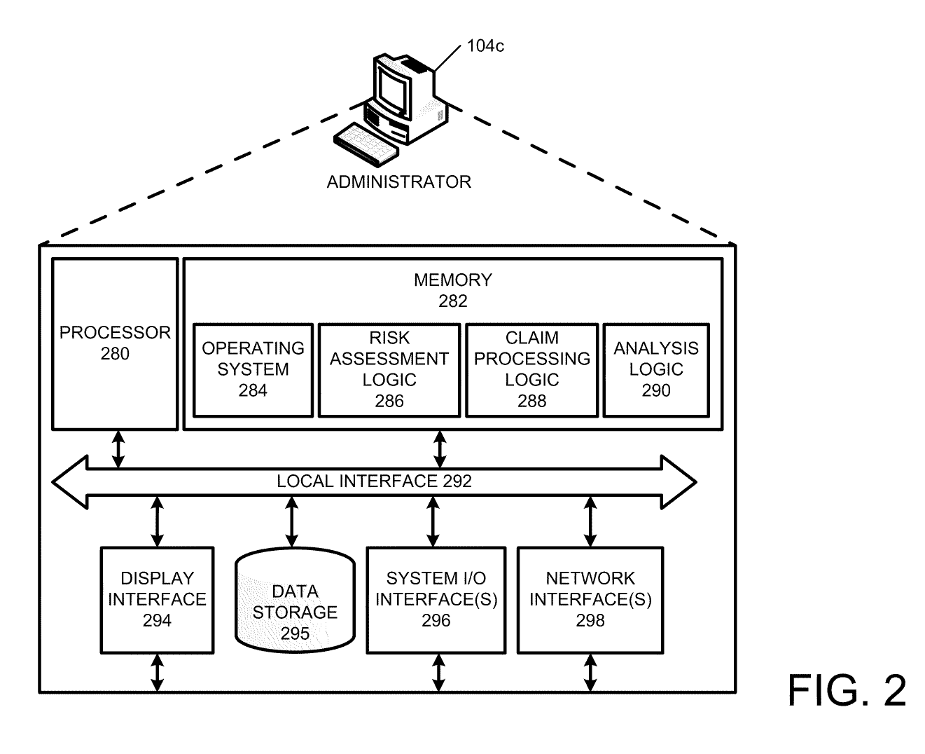

FIG. 2 illustrates a nonlimiting example of a computing device, such as may be utilized in providing and/or fulfilling a loss mitigation instrument such as in the environment from FIG. 1.

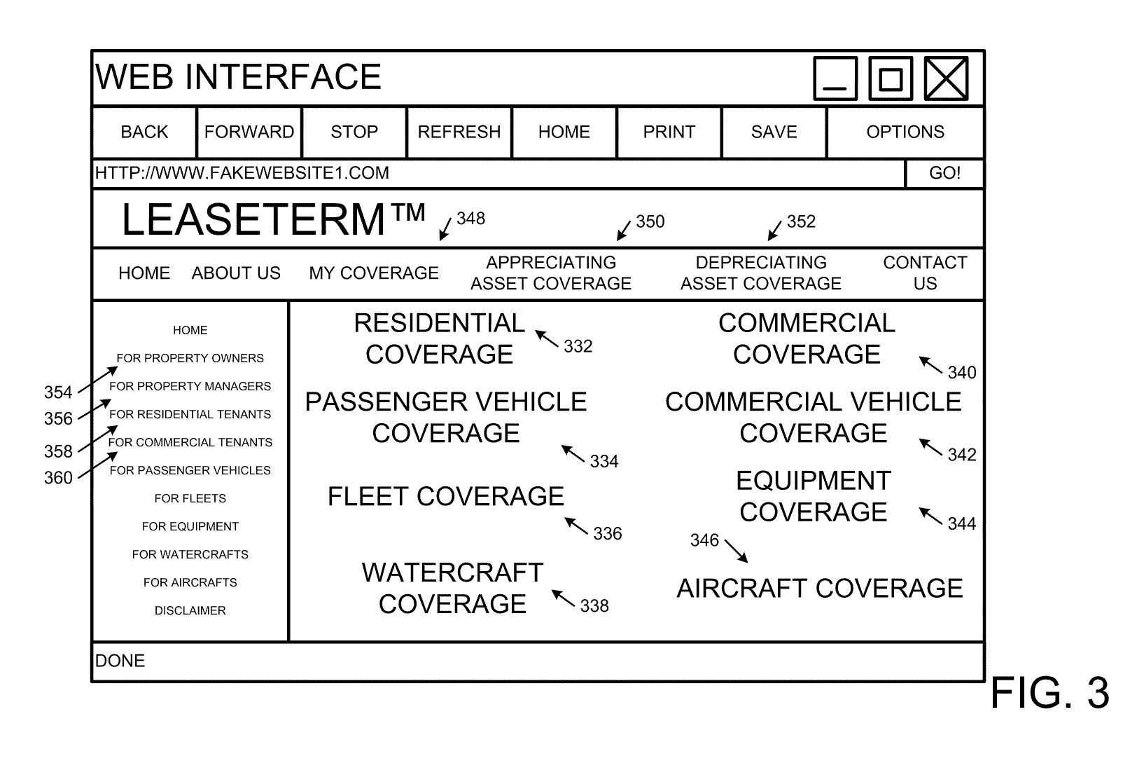

FIG. 3 illustrates a nonlimiting example of a user interface for providing options related to a loss mitigation instrument, such as may be provided by the computing device from FIG. 2.

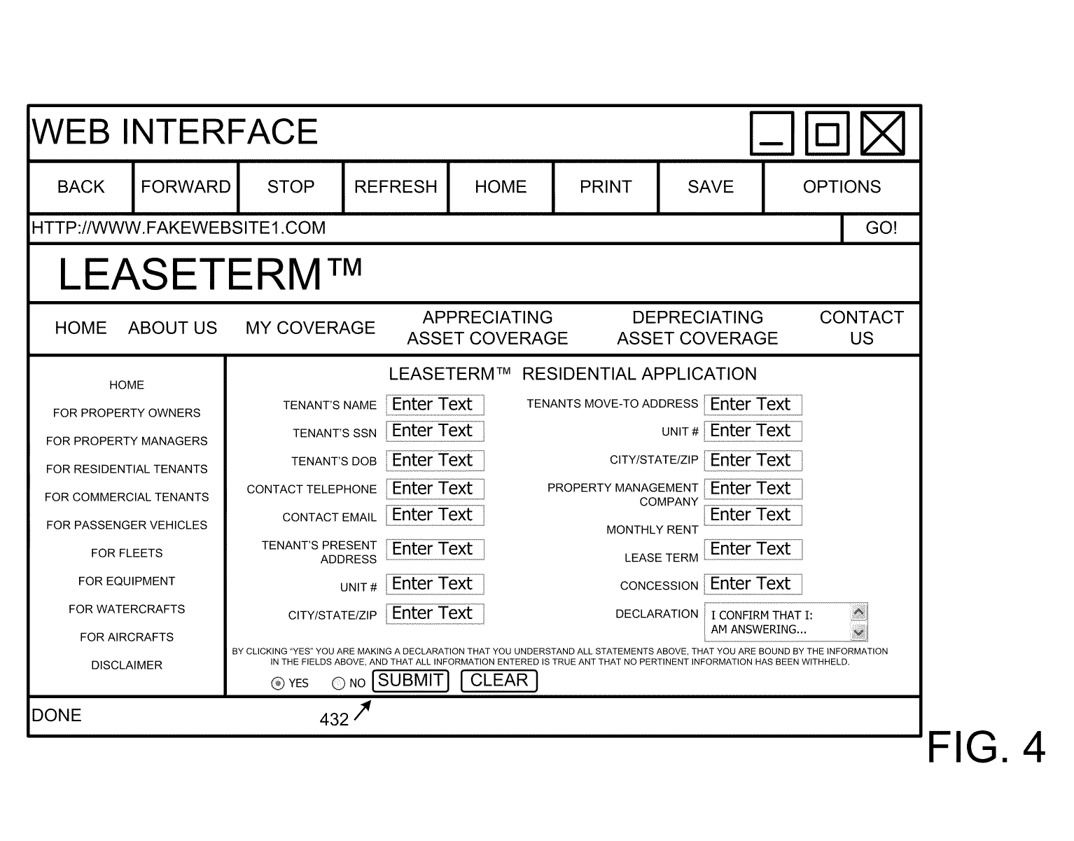

FIG. 4 illustrates a nonlimiting example user interface for providing a loss mitigation instrument application, similar to the user interface from FIG. 3.

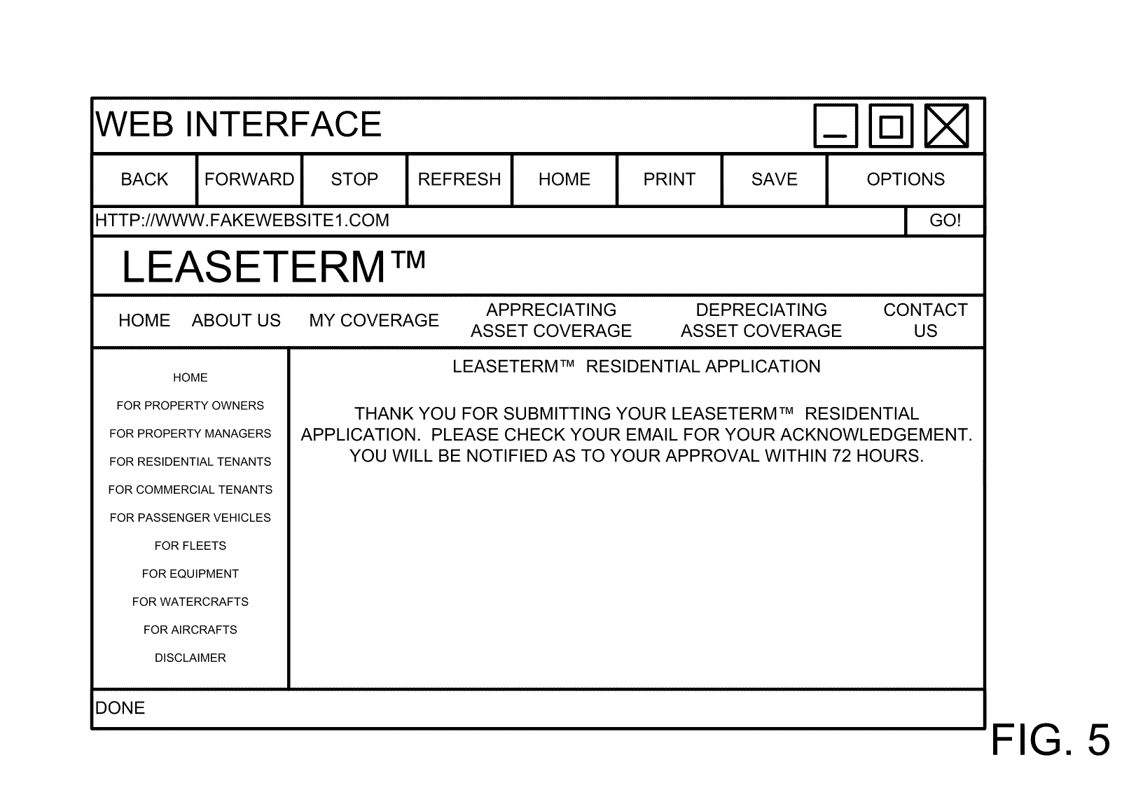

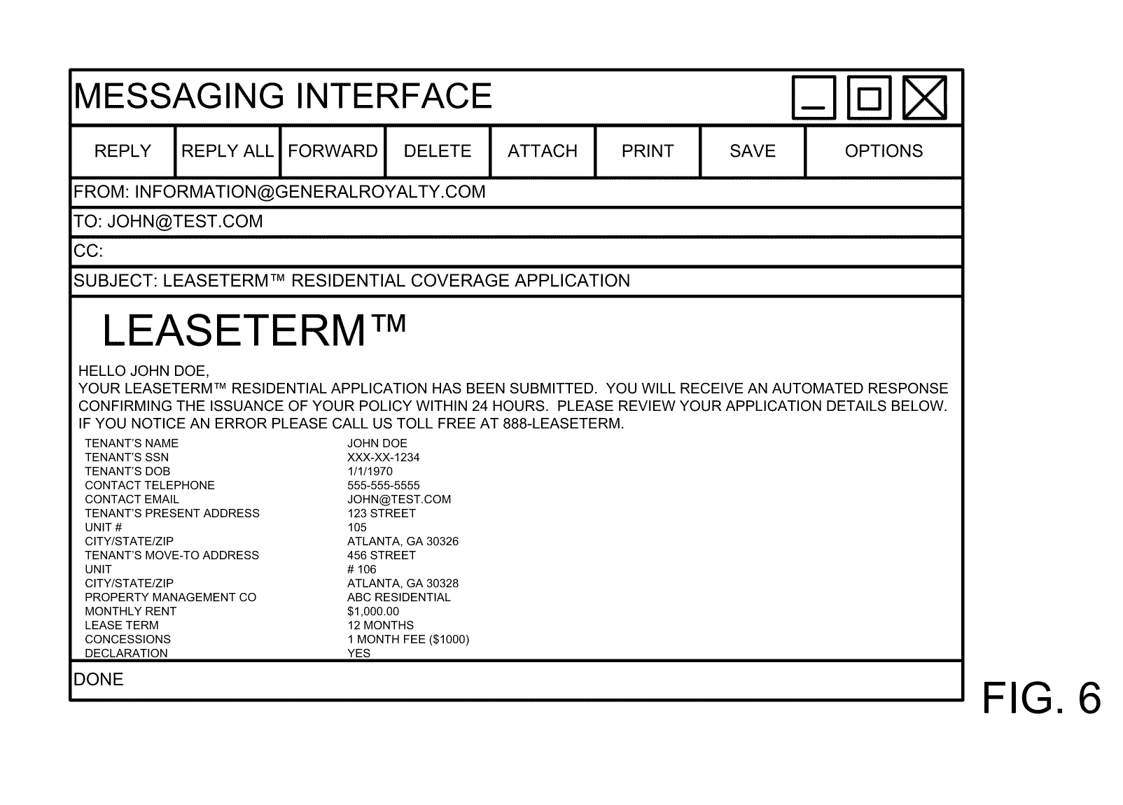

FIG. 5 illustrates a nonlimiting example embodiment of a user interface for confirming receipt of a loss mitigation instrument application, similar to the interface from FIG. 4.

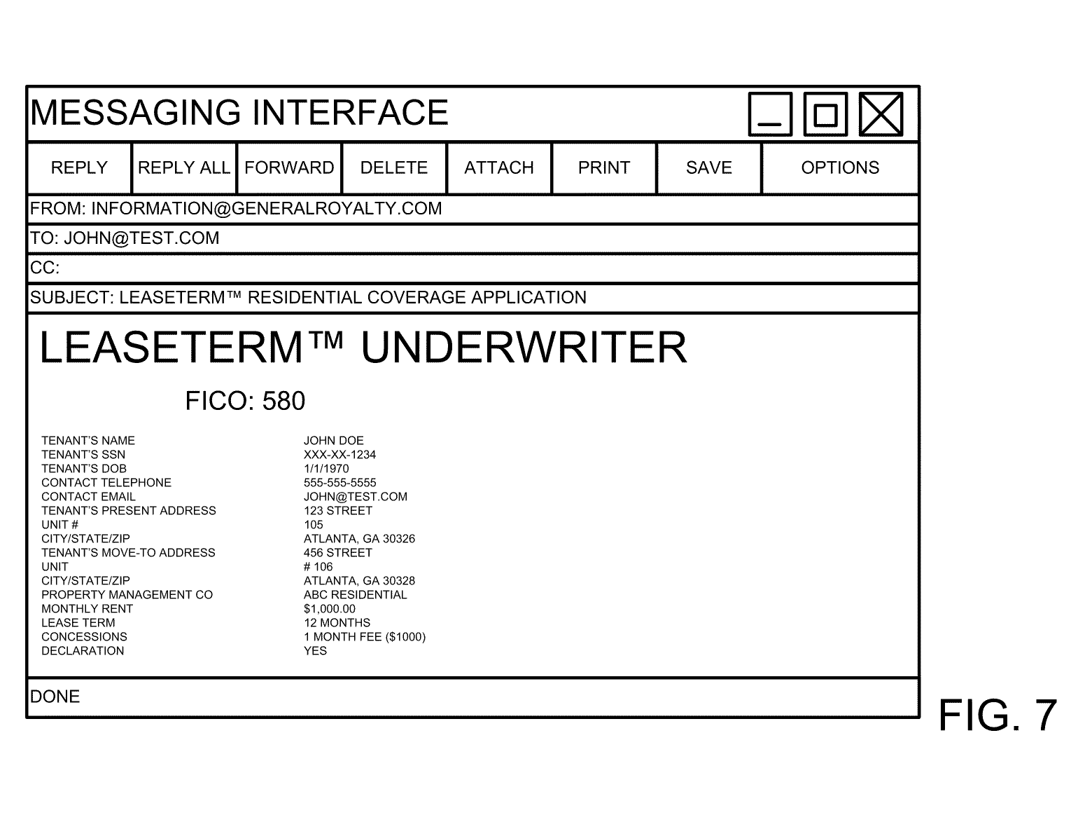

FIG. 6 illustrates a nonlimiting example of a user interface for confirming information submitted via the interface from FIG. 4.

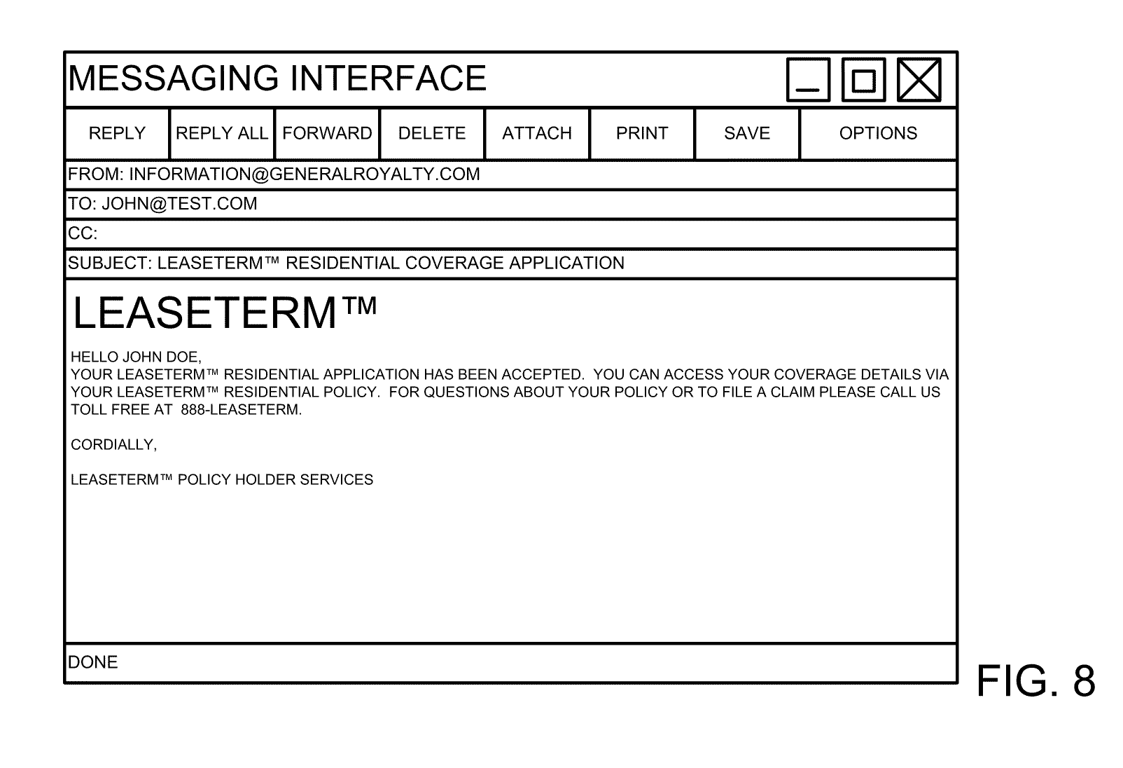

FIG. 7 illustrated a nonlimiting example of a user interface for providing a fair Isaac Company (FICO) score for the applicant illustrated in FIG. 6.

FIG. 8 illustrates a nonlimiting example of a user interface for illustrating acceptance of the application, similar to the interface from FIG. 4.

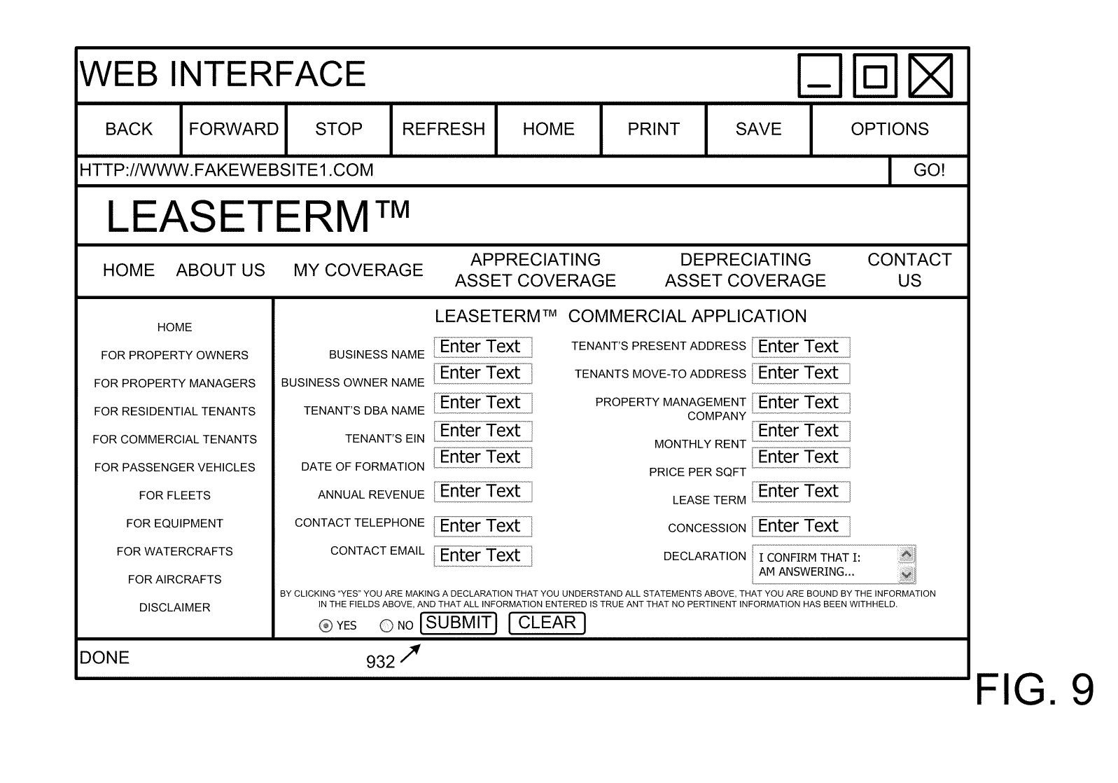

FIG. 9 illustrates a nonlimiting example of a user interface for providing a commercial application for a loss mitigation instrument, similar to the application illustrated in FIG. 4.

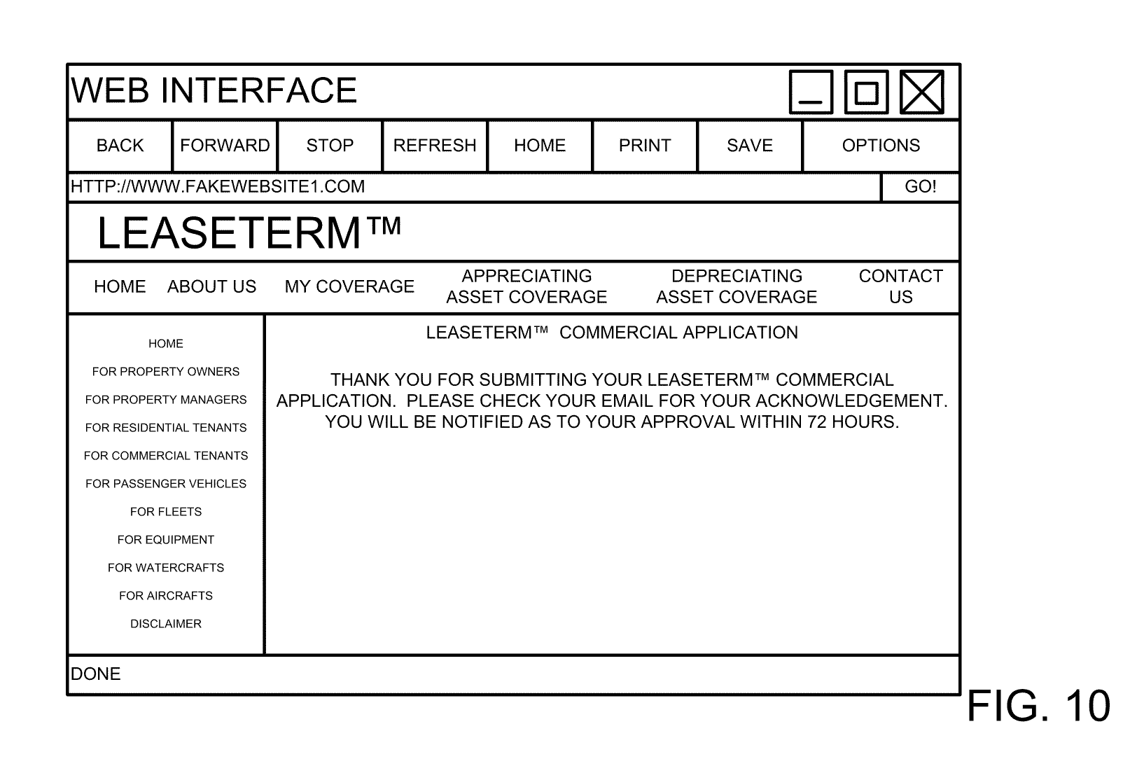

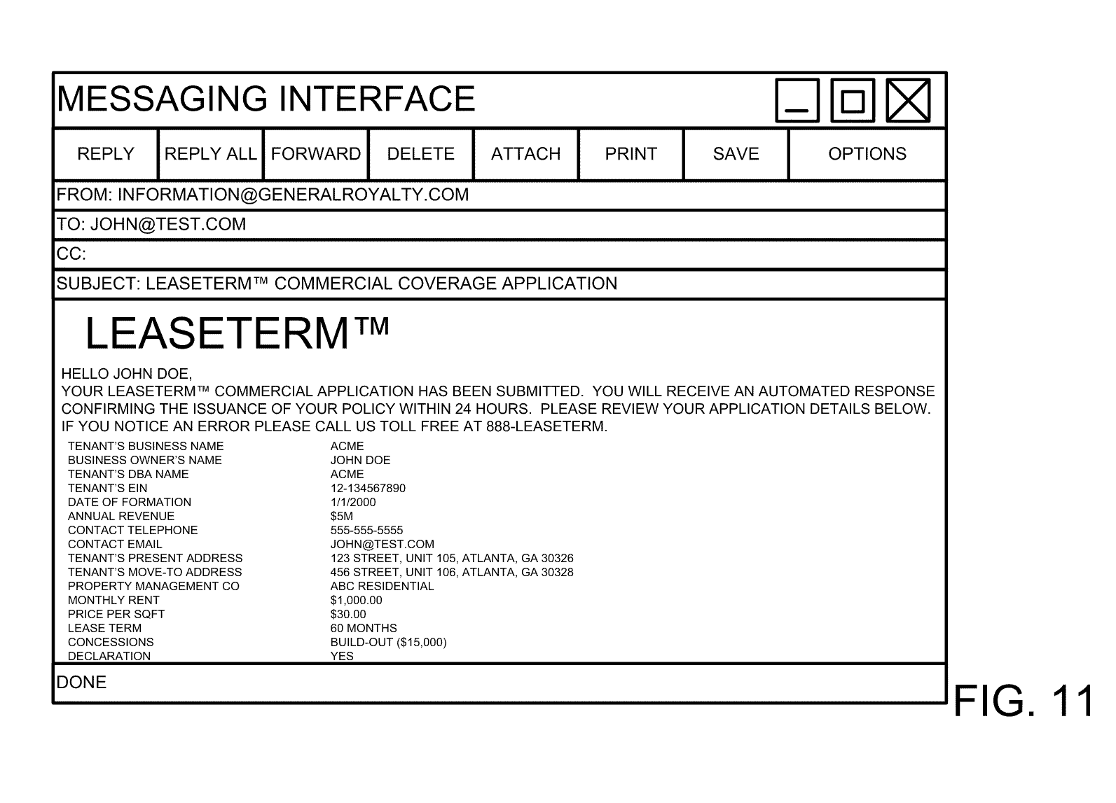

FIG. 10 illustrates a nonlimiting example of a user interface for indicating that a commercial loss mitigation instrument application is received, similar to the interface from FIG. 5.

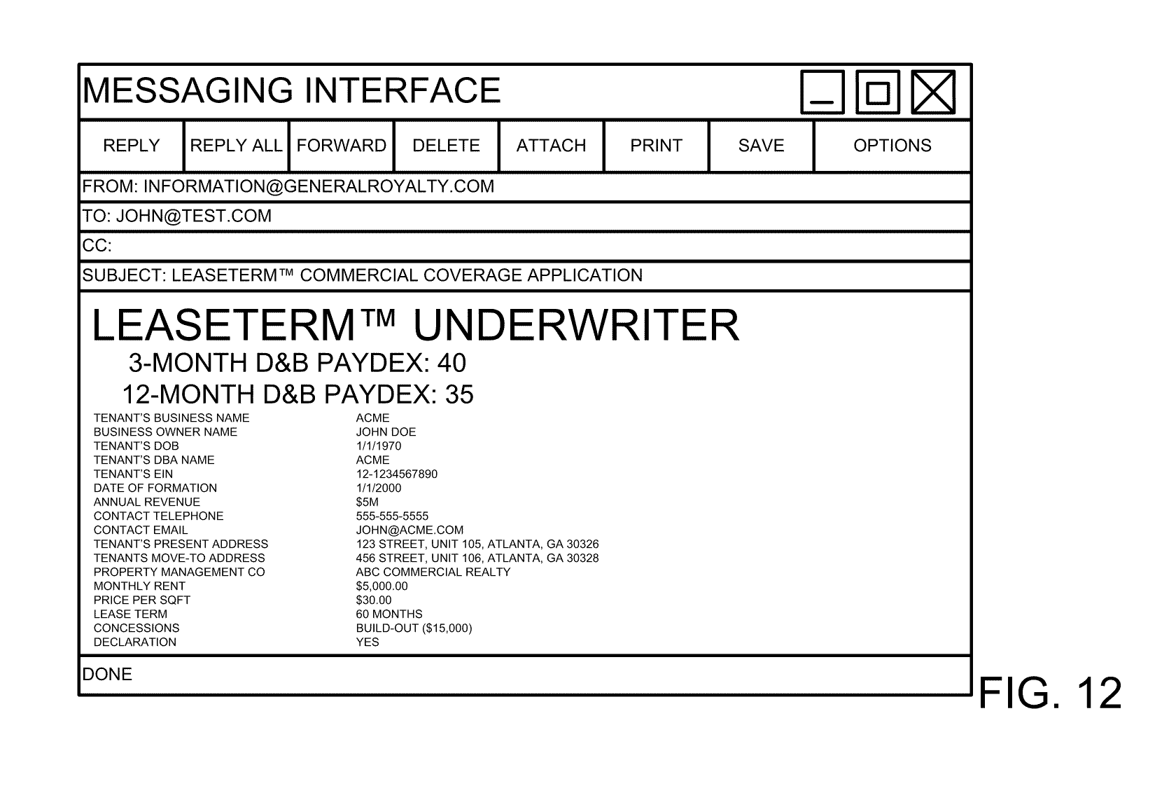

FIG. 11 illustrates a nonlimiting example of a user interface for confirming information submitted via the interface from FIG. 6.

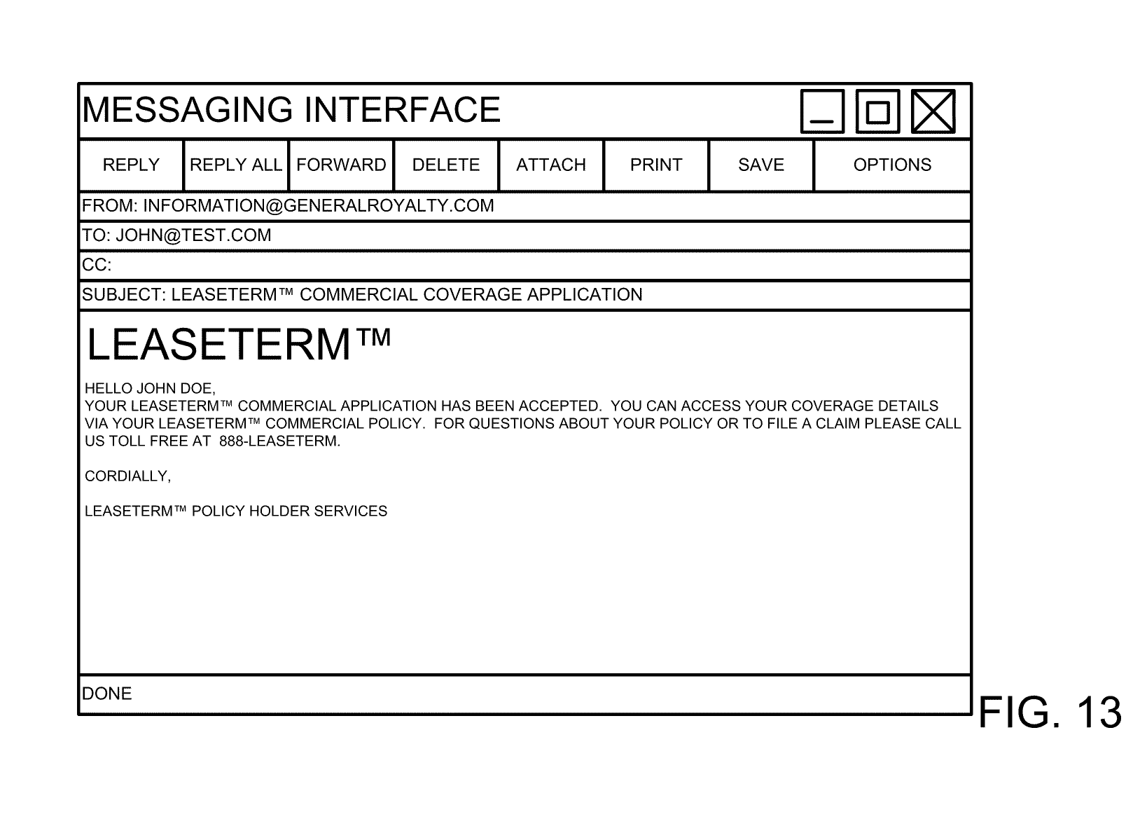

FIG. 12 illustrates a nonlimiting example of a user interface for indicating Dunn and Bradstreet (D&B) ratings and a Paydex score, similar to the interface from FIG. 7.

FIG. 13 illustrates a nonlimiting example of a user interface for indicating that a commercial loss mitigation instrument application is accepted, similar to the interface from FIG. 8.

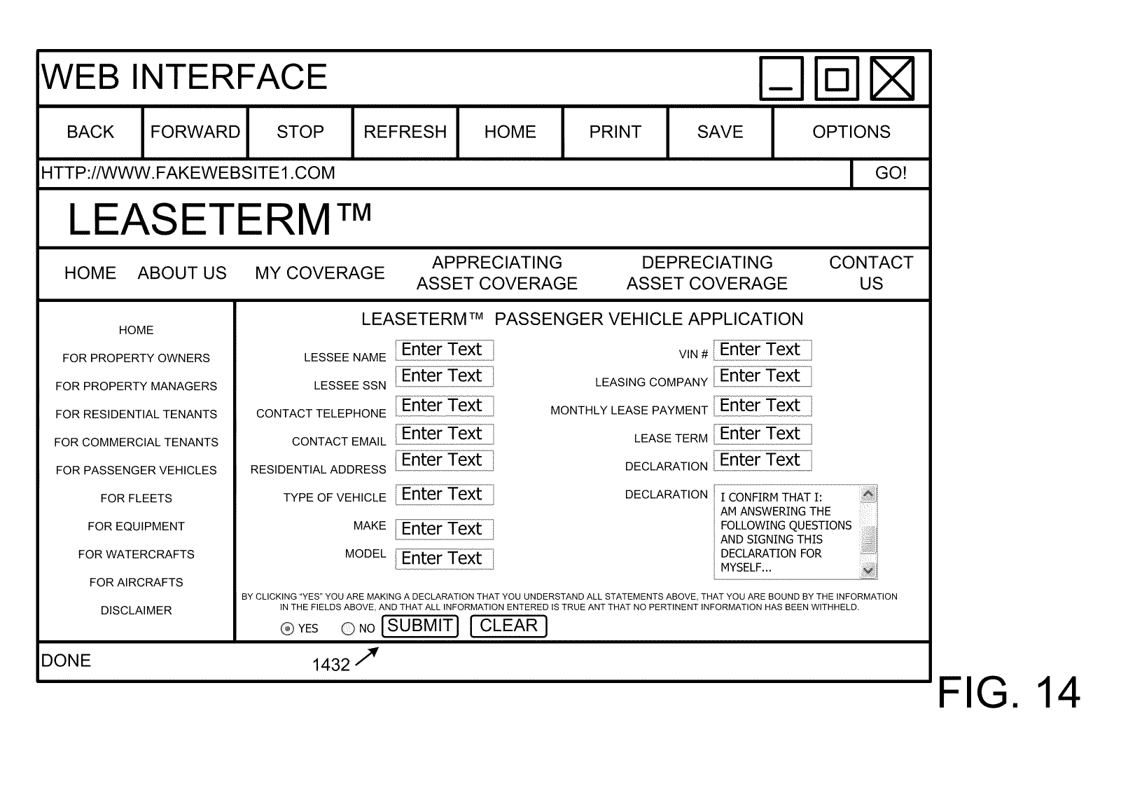

FIG. 14 illustrates a nonlimiting example of a user interface for providing a passenger vehicle loss mitigation instrument application, similar to the interface from FIG. 9.

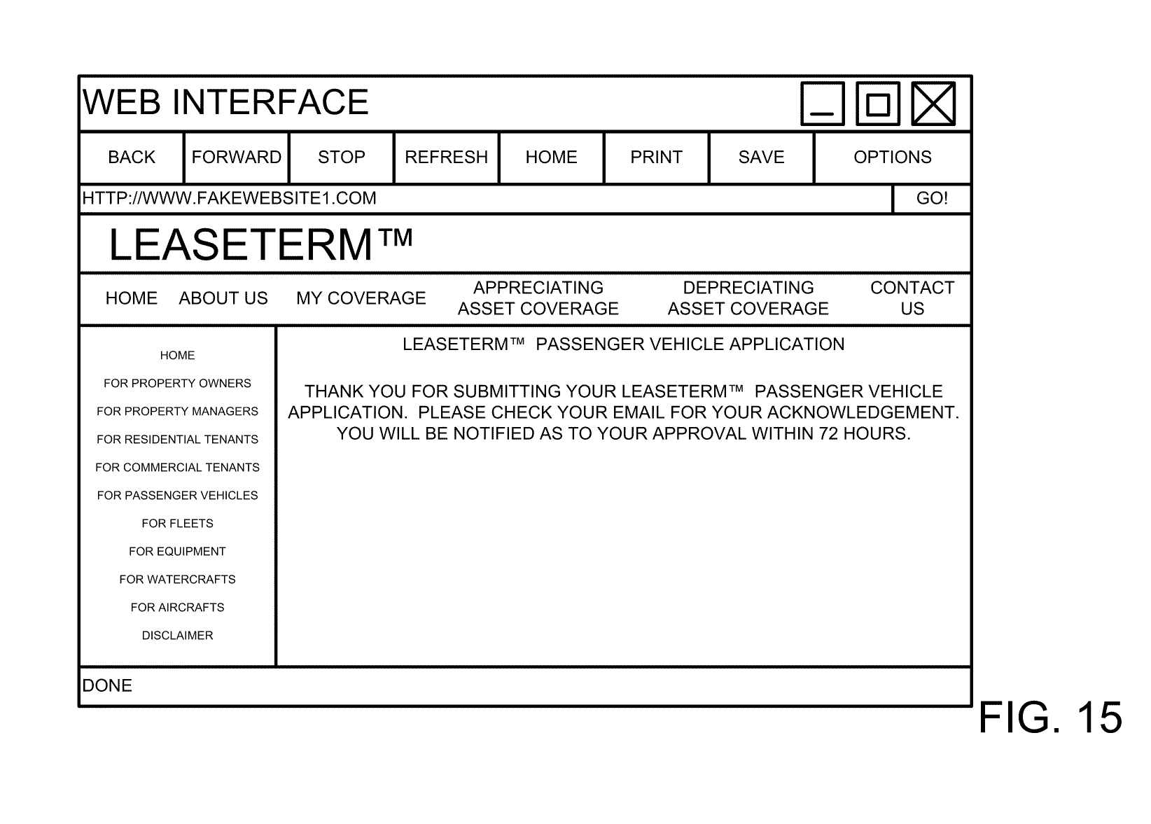

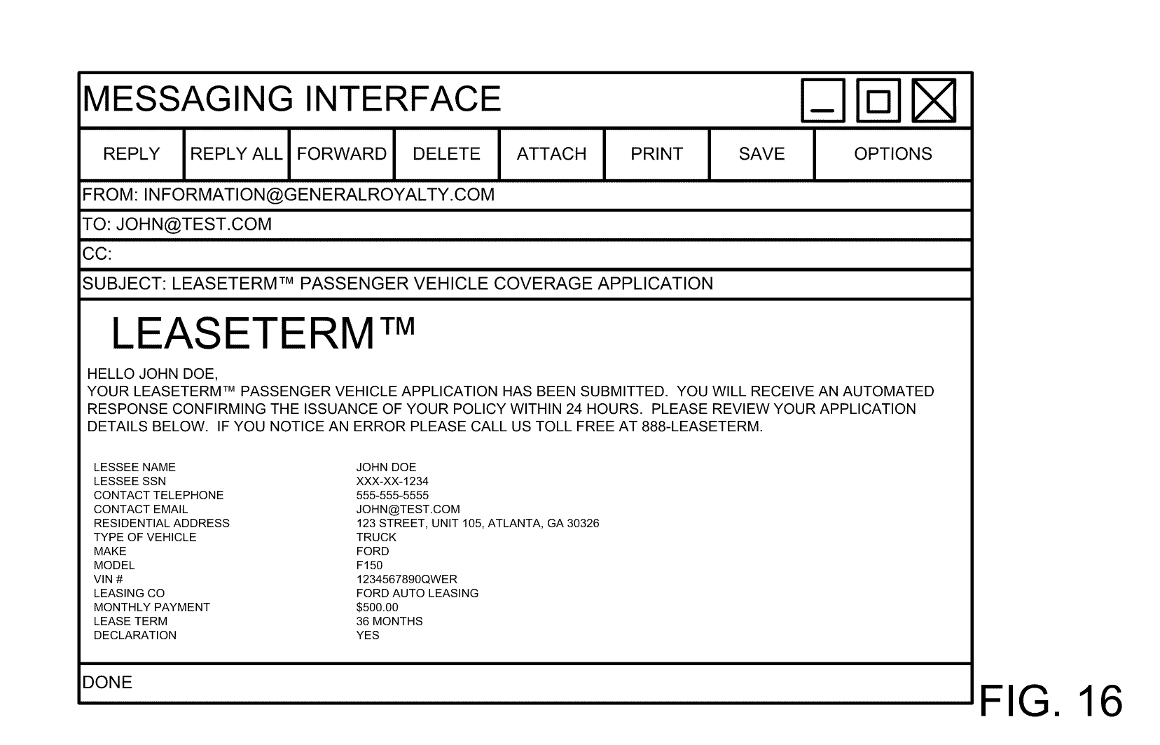

FIG. 15 illustrates a nonlimiting example of a user interface for indicating that a passenger vehicle loss mitigation instrument application is submitted, similar to the diagram from FIG. 10.

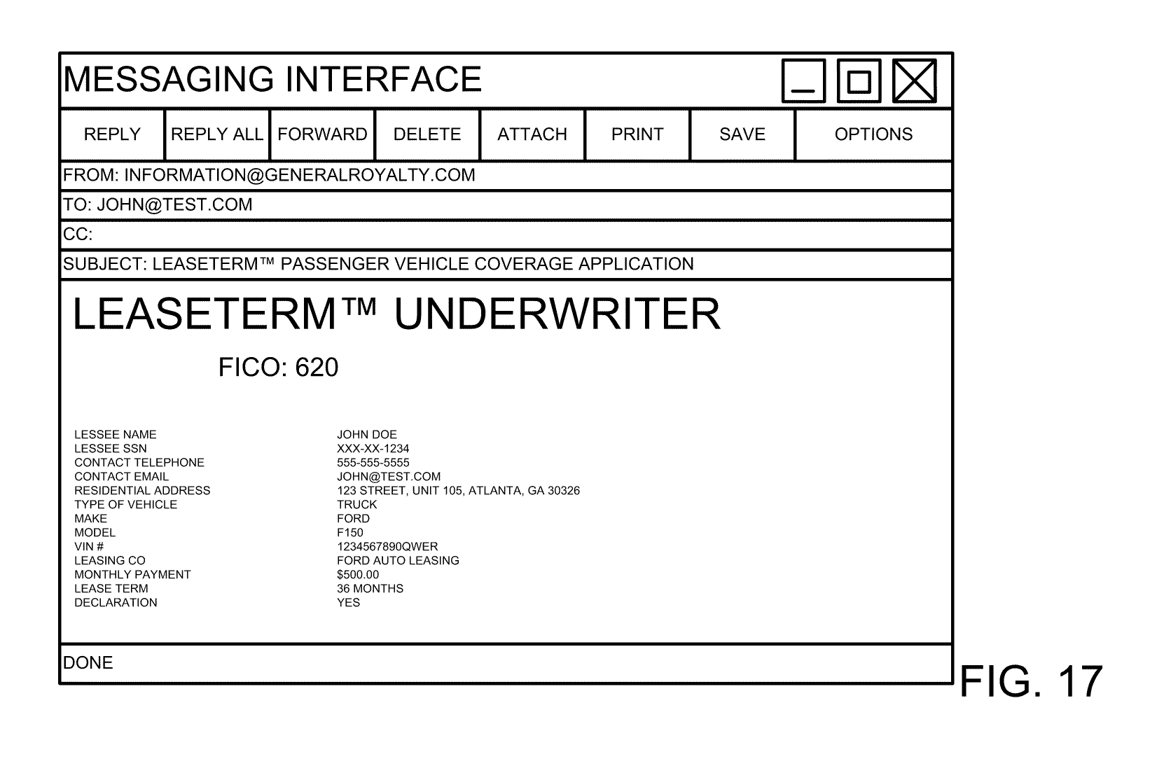

FIG. 16 illustrates a nonlimiting example of a user interface for confirming information submitted via the interface from FIG. 11.

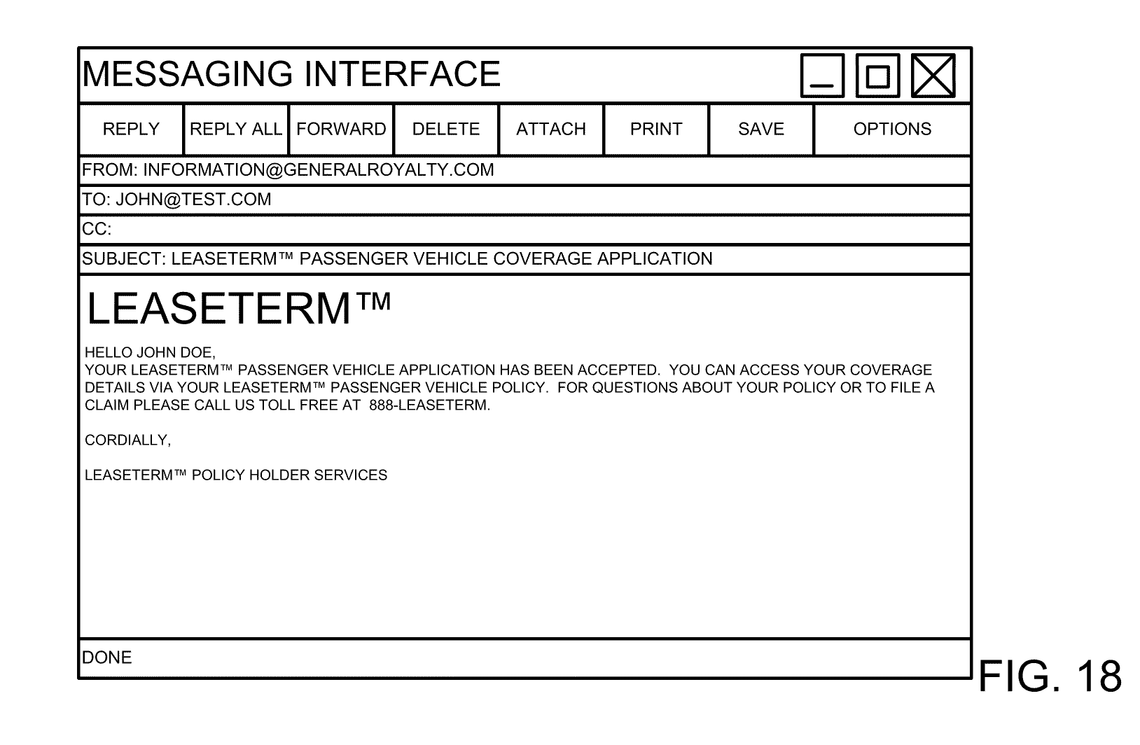

FIG. 17 illustrates a nonlimiting example of a user interface for indicating a FICO score of an applicant, similar to the interface from FIG. 7.

FIG. 18 illustrates a nonlimiting example of a user interface for indicating that a passenger vehicle loss mitigation instrument application is accepted, similar to the interface from FIG. 13.

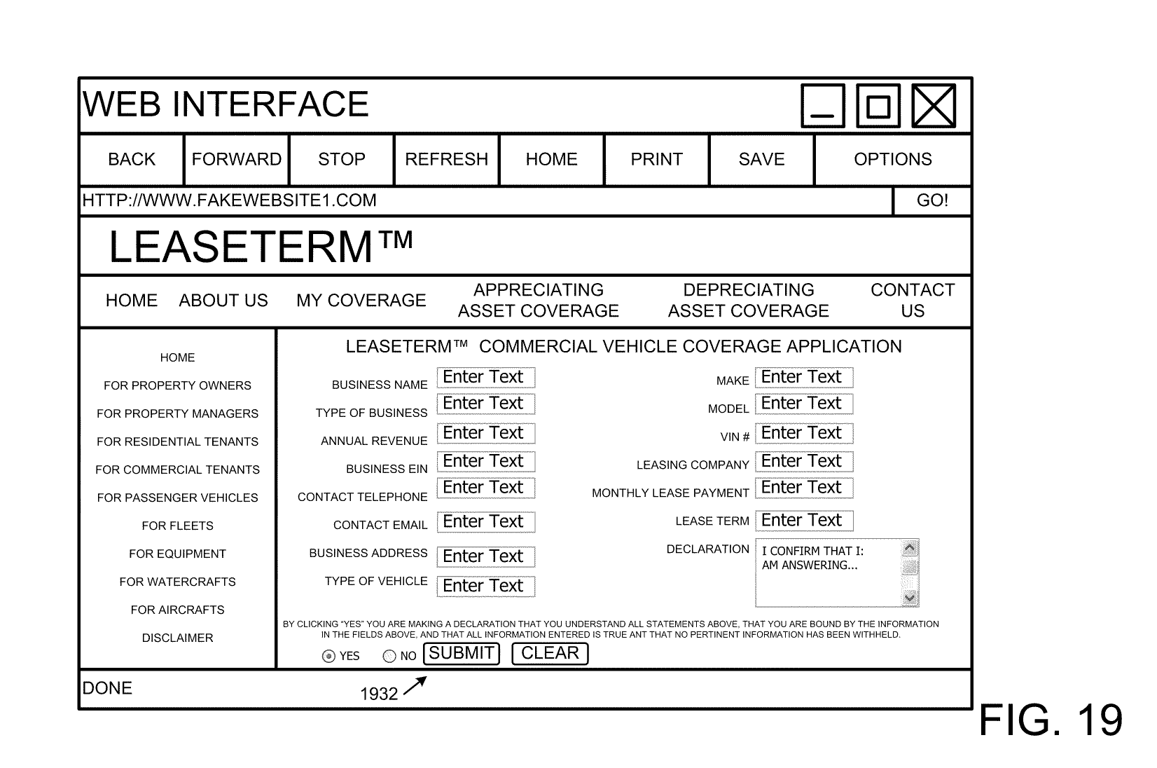

FIG. 19 illustrates a nonlimiting example of a user interface for providing a commercial vehicle loss mitigation instrument application, similar to the interface from FIG. 14.

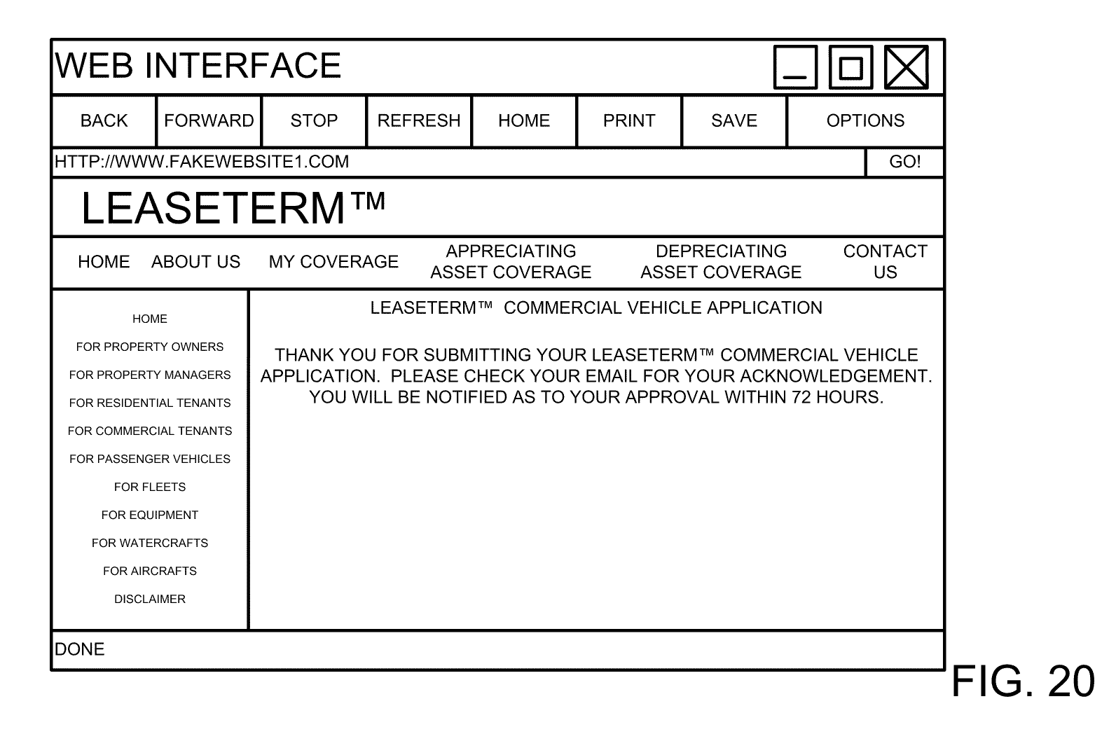

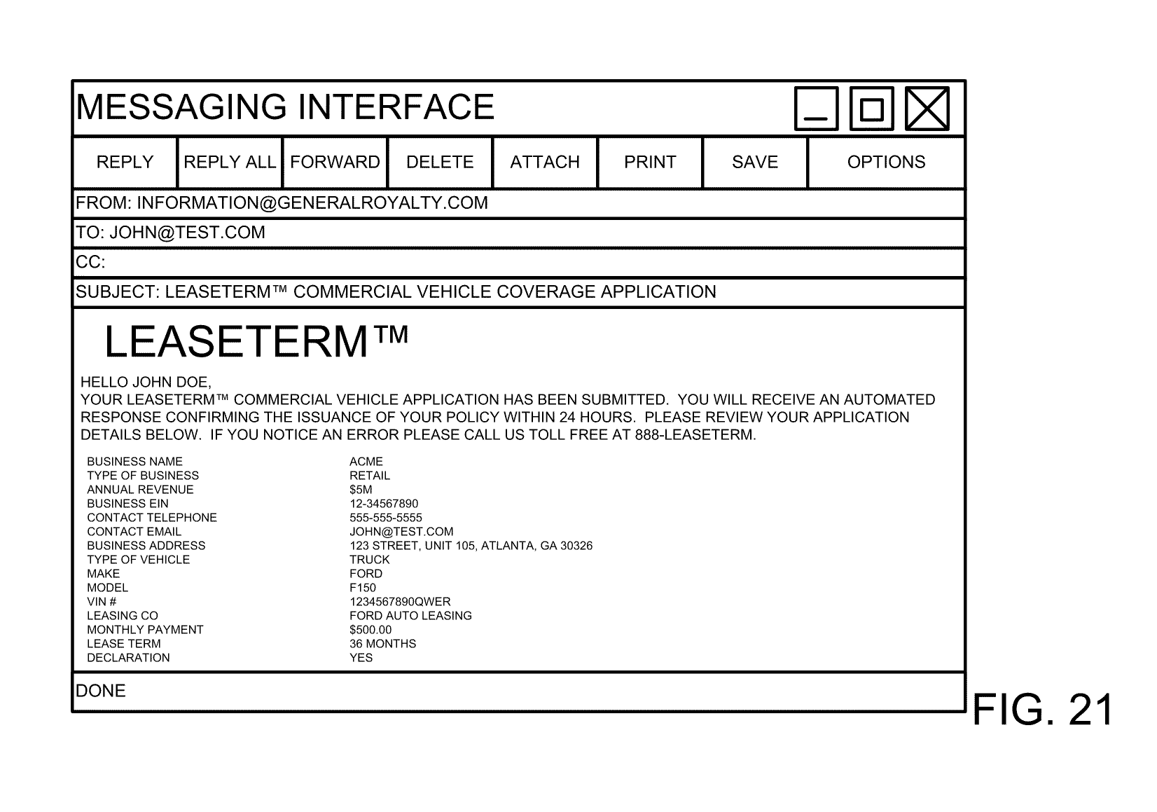

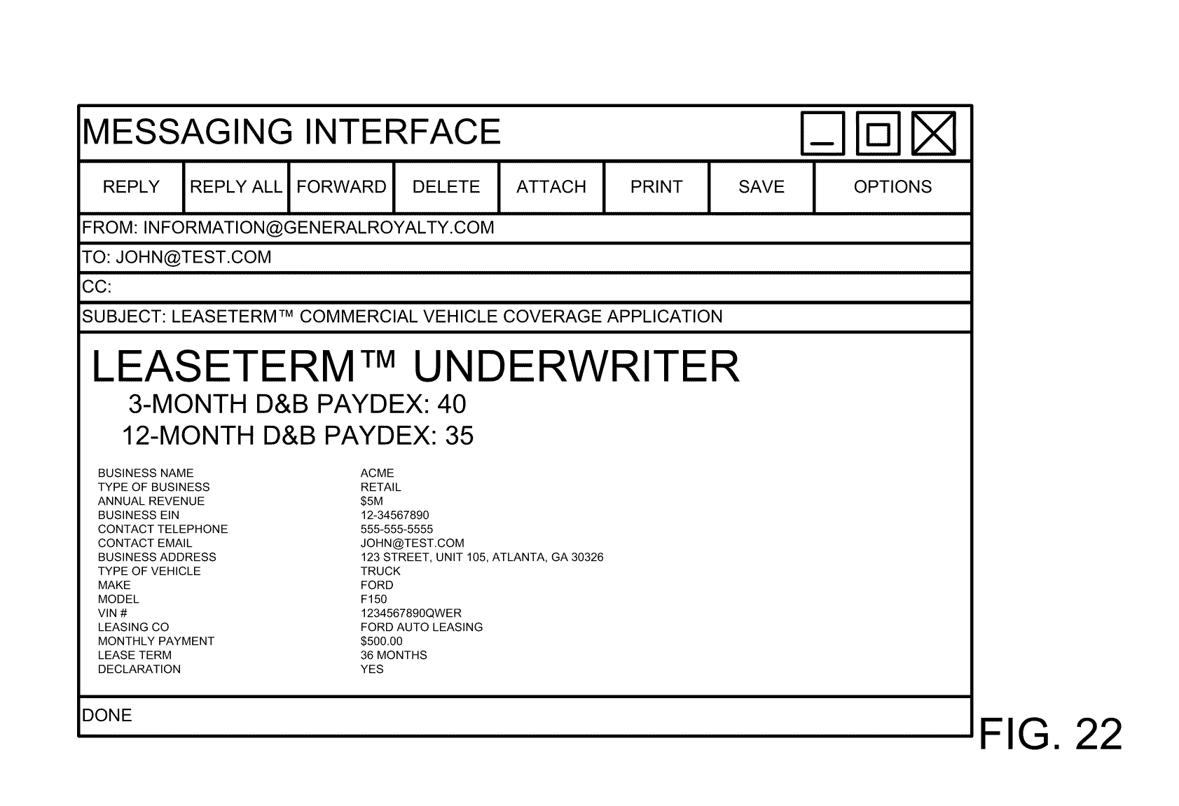

FIG. 20 illustrates a nonlimiting example of a user interface for indicating that a commercial vehicle loss mitigation instrument application is submitted, similar to the diagram from FIG. 15.

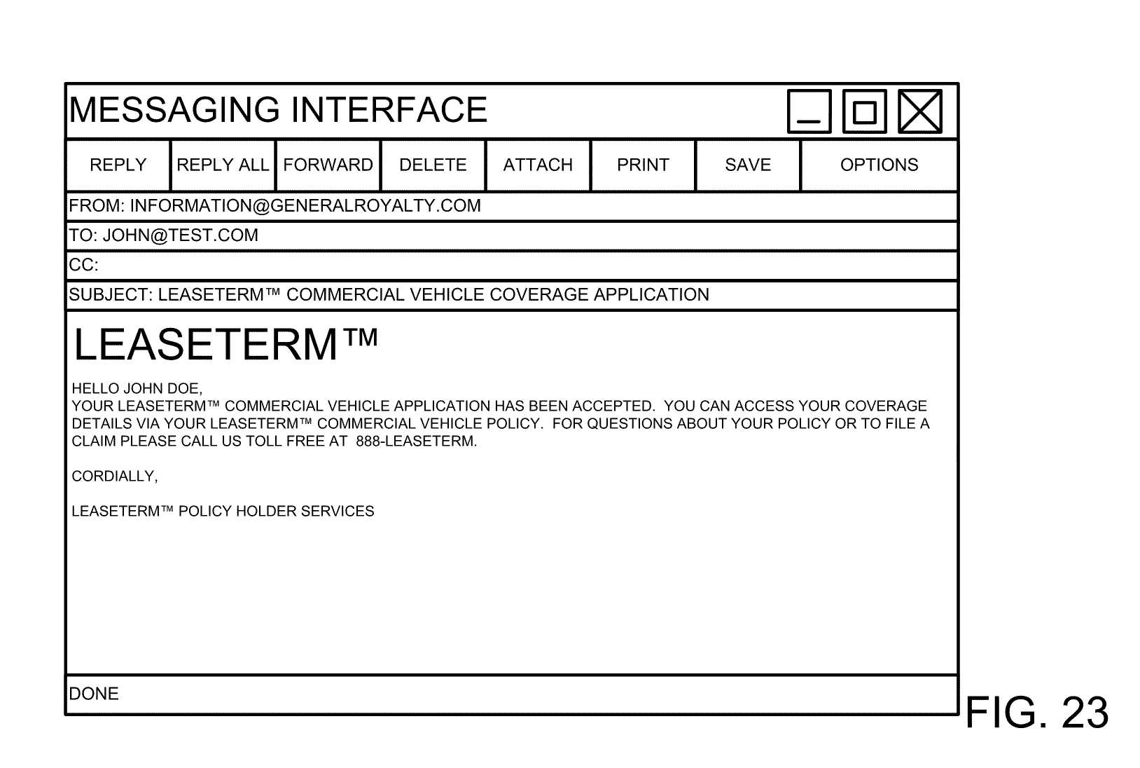

FIG. 21 illustrates a nonlimiting example of a user interface for confirming information submitted via the interface from FIG. 16.

FIG. 22 illustrates a nonlimiting example of a user interface for indicating Dunn and Bradstreet (D&B) ratings and a Paydex score, similar to the interface from FIG. 12.

FIG. 23 illustrates a nonlimiting example of a user interface for indicating that a commercial vehicle loss mitigation instrument application is accepted, similar to the interface from FIG. 18.

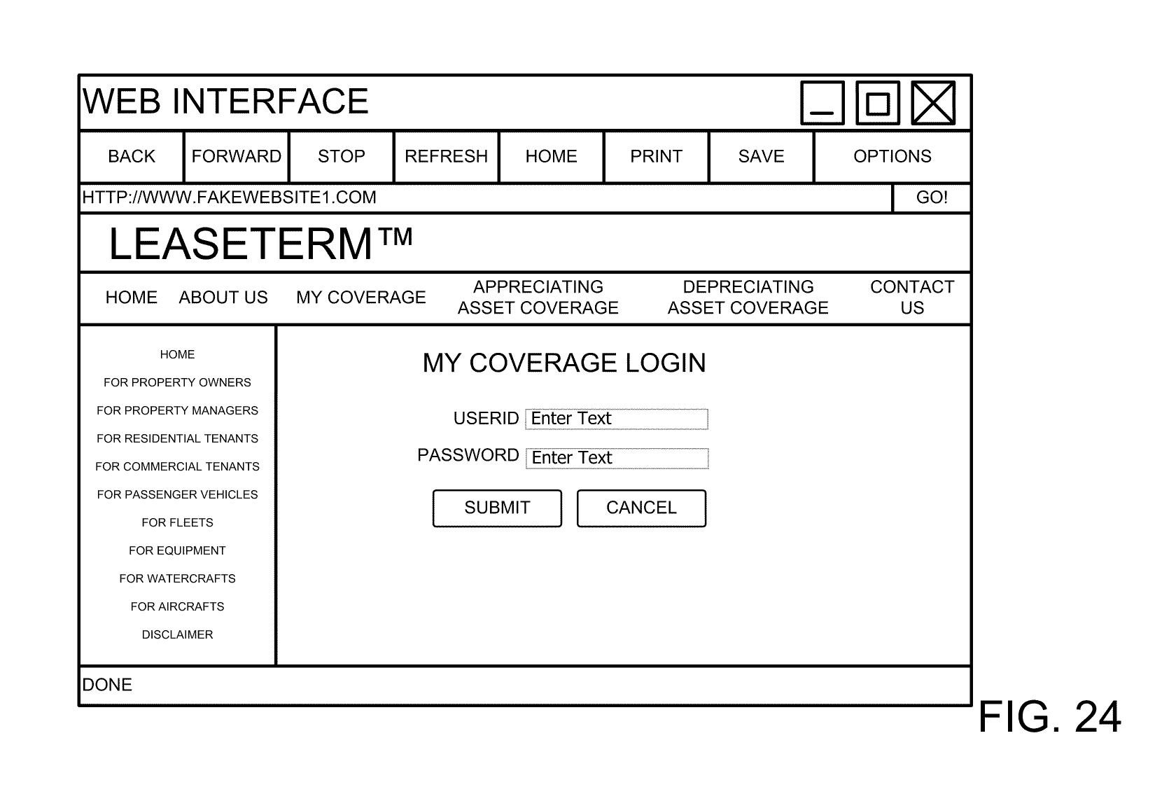

FIG. 24 illustrates a nonlimiting example of a user interface for accessing an account of the loss mitigation system, as may be accessed from the interface in FIG. 3.

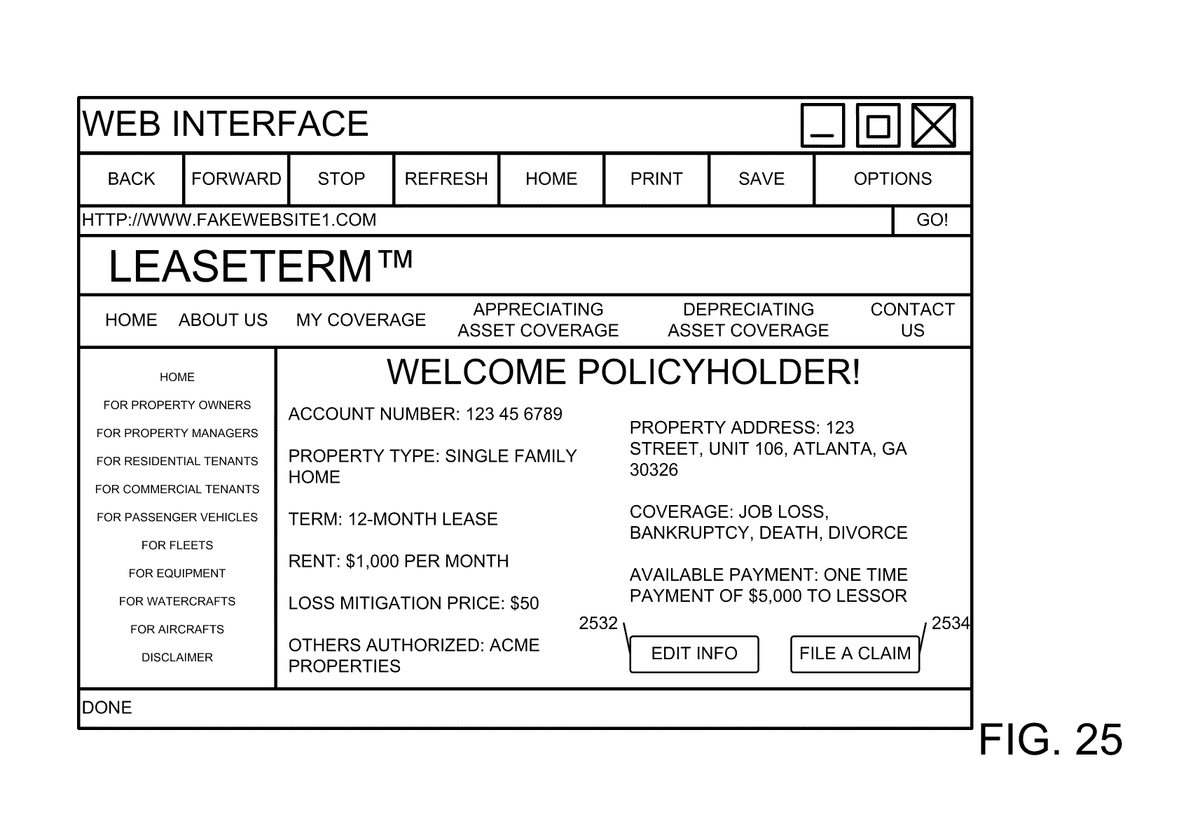

FIG. 25 illustrates a nonlimiting example of a user interface for showing account information, in response to a successful authentication, as may be accessed from the interface from FIG. 24.

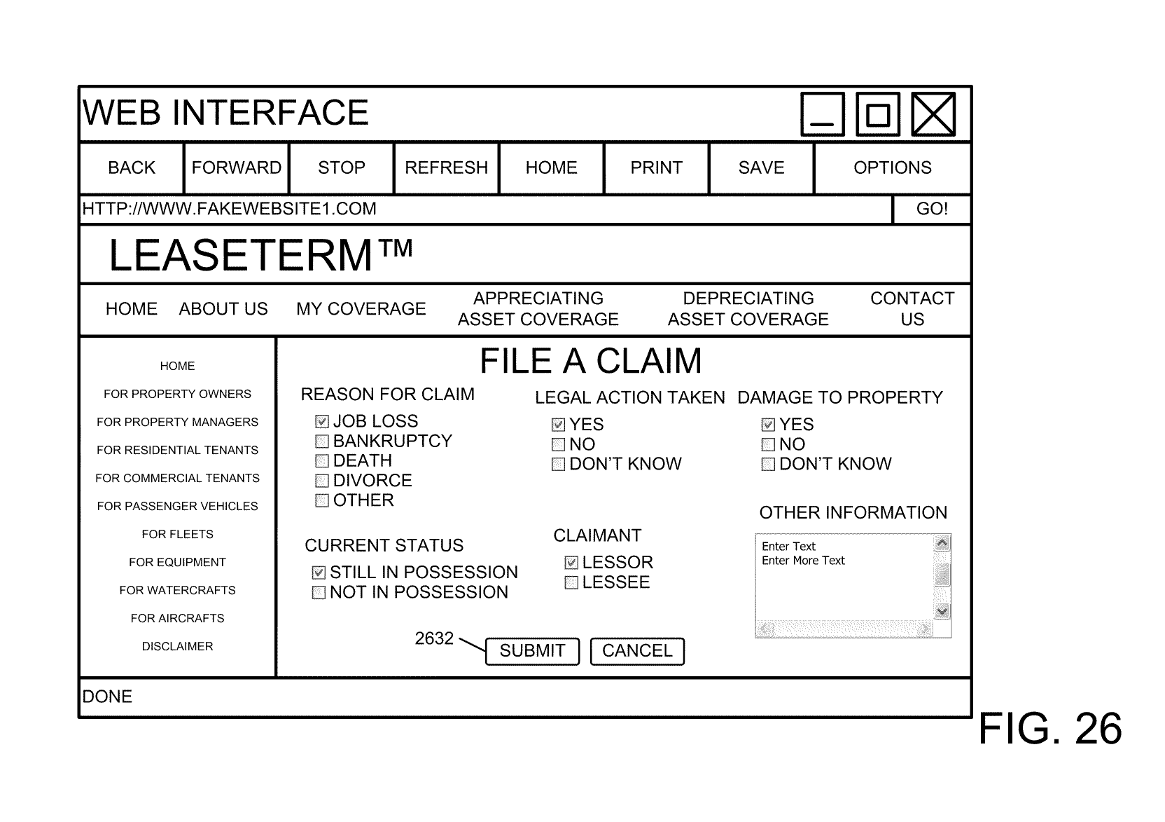

FIG. 26 illustrates a nonlimiting example of a user interface for filing a claim on an existing loss mitigation instrument, similar to the interface from FIG. 25.

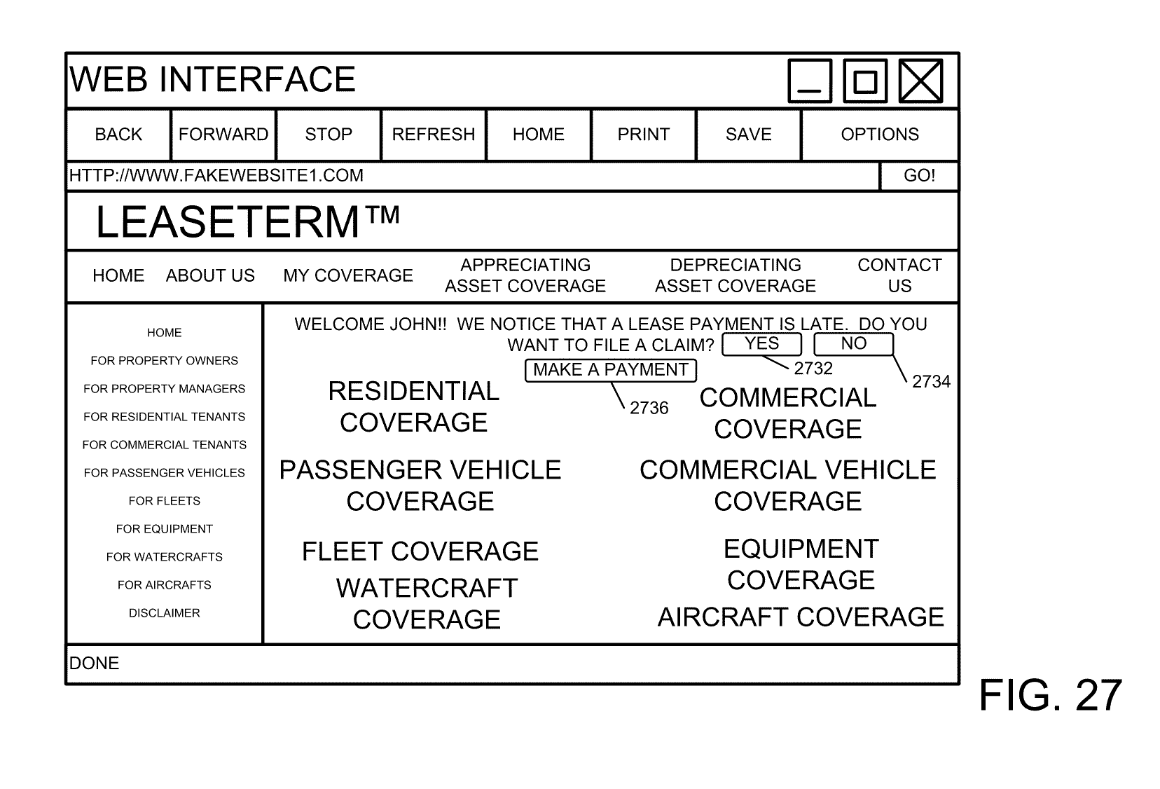

FIG. 27 illustrates a nonlimiting example of a user interface for providing intuitive information to a user, similar to the interface from FIG. 3.

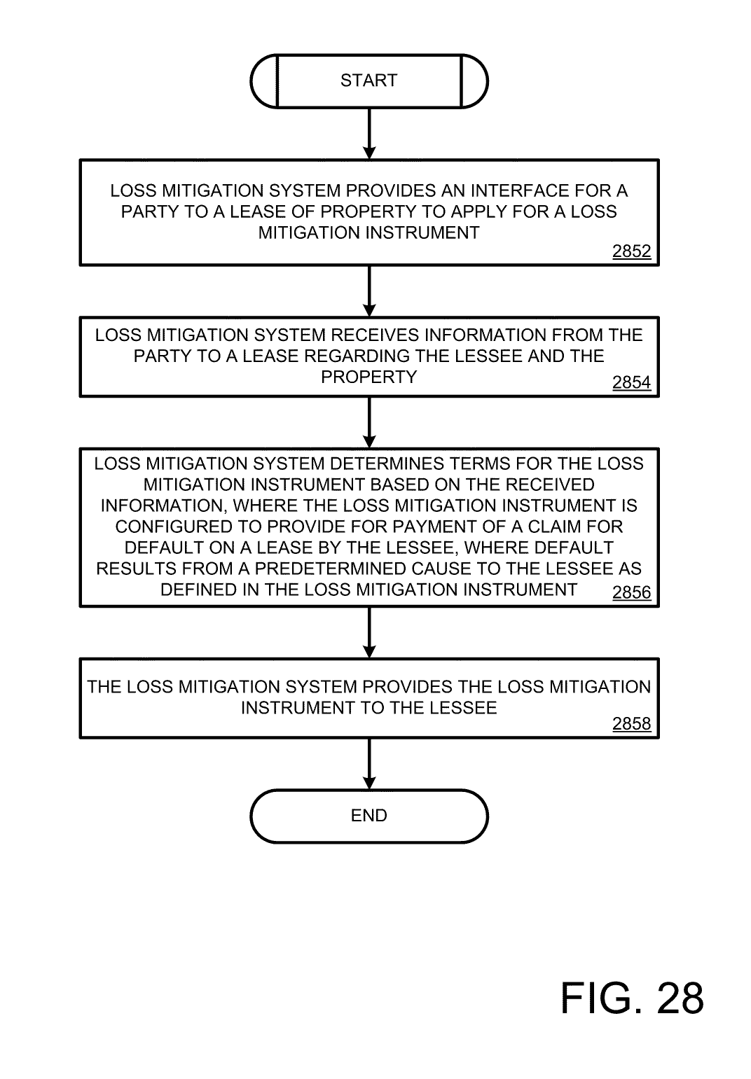

FIG. 28 illustrates a nonlimiting example of a process for creating a loss mitigation instrument, such as in the environment of FIG. 1.

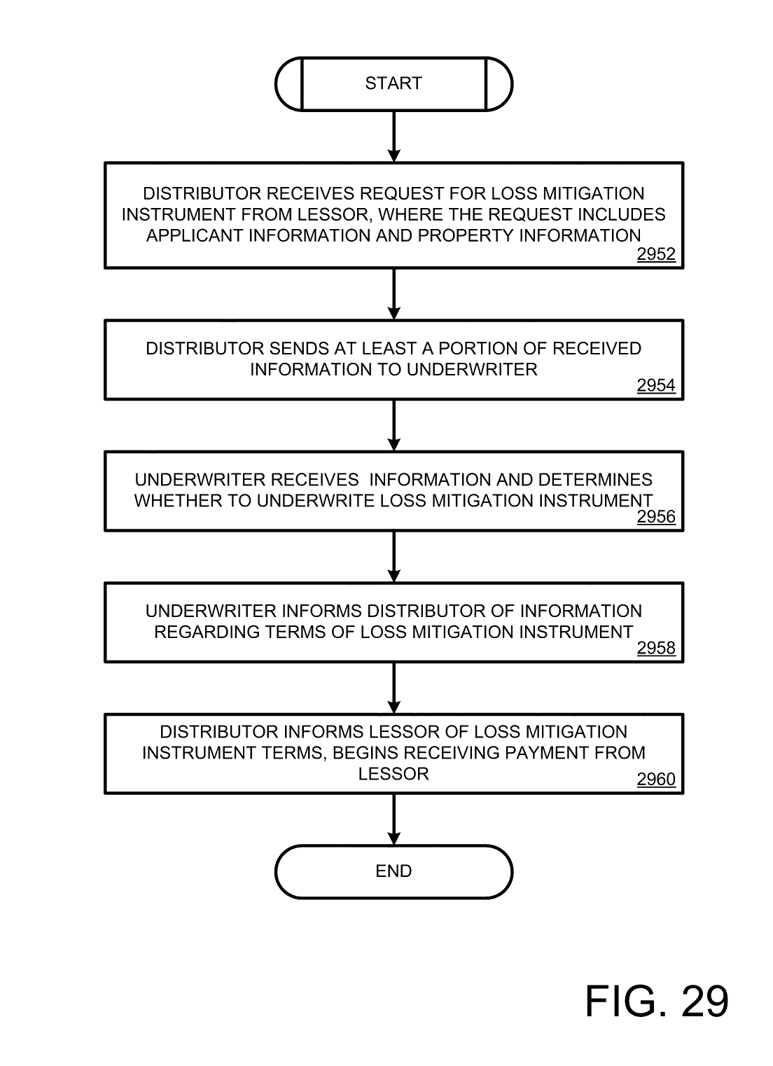

FIG. 29 illustrates a nonlimiting example of a process that may be utilized for initiating a loss mitigation instrument, similar to the process from FIG. 28.

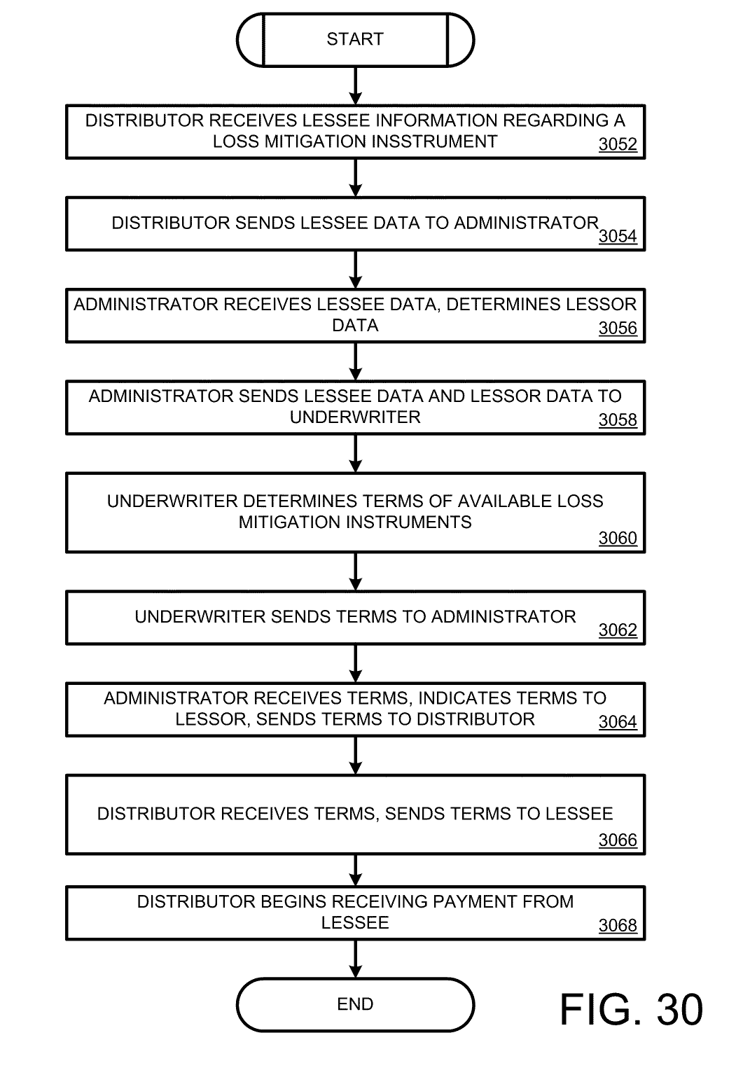

FIG. 30 illustrates another nonlimiting example of a process that may be utilized for initiating and/or administrating a loss mitigation instrument, similar to the process from FIG. 29.

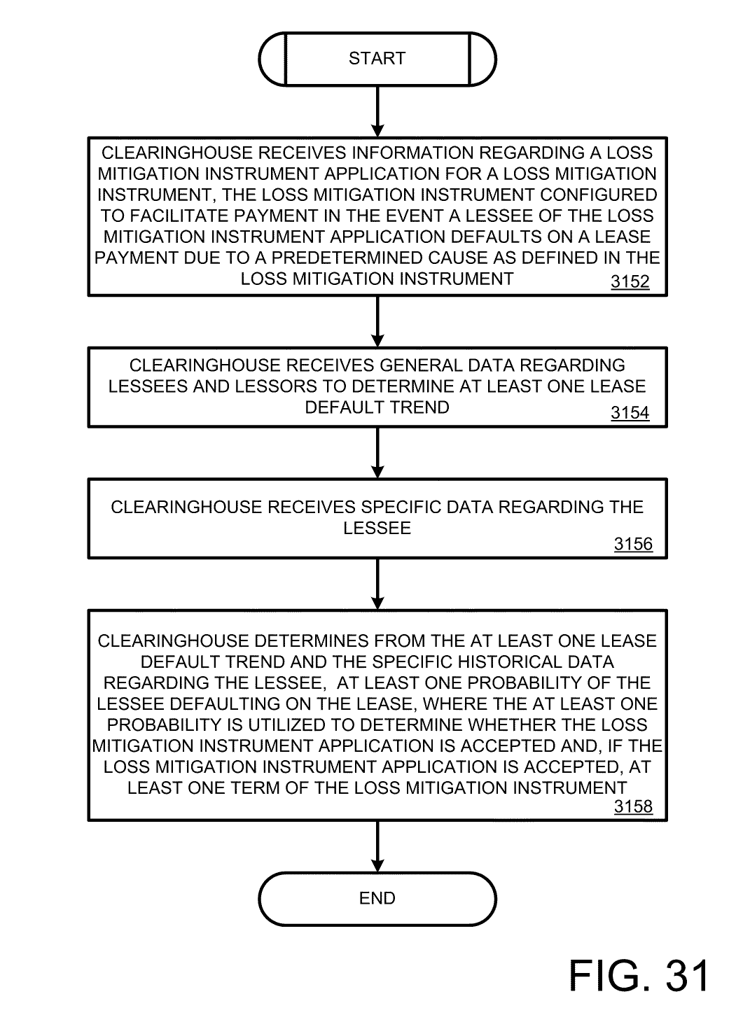

FIG. 31 illustrates a nonlimiting example of a process for analyzing lease default data, similar to the process from FIG. 30.

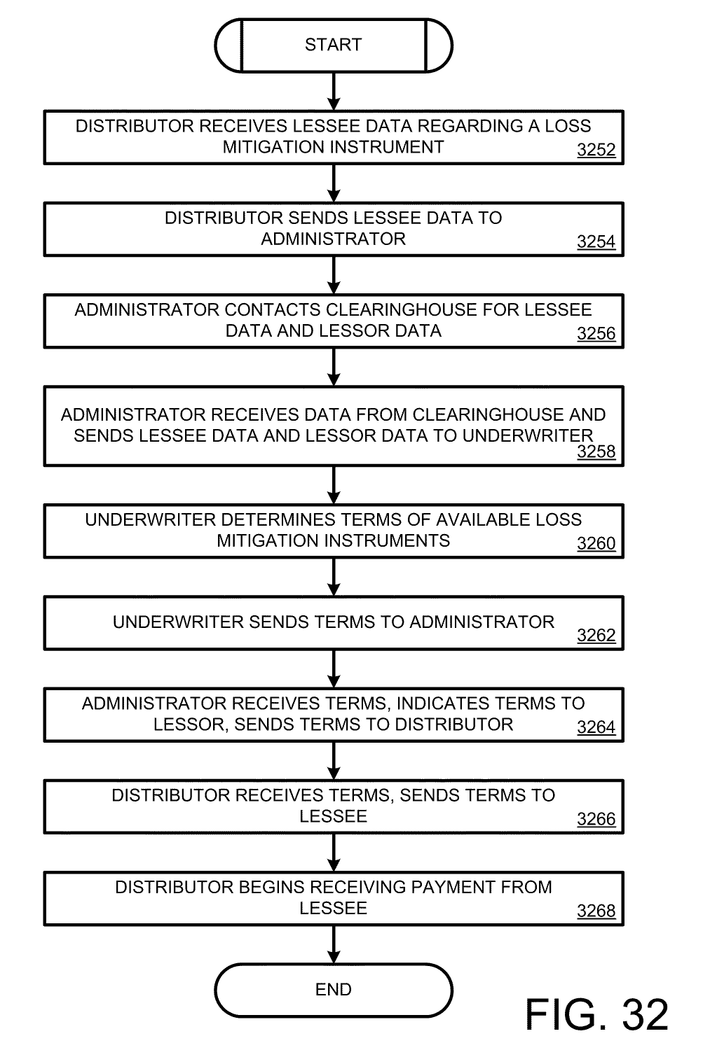

FIG. 32 illustrates a nonlimiting example of a process for utilizing a clearinghouse in initiating and/or administrating a loss mitigation instrument, similar to the process from FIG. 31.

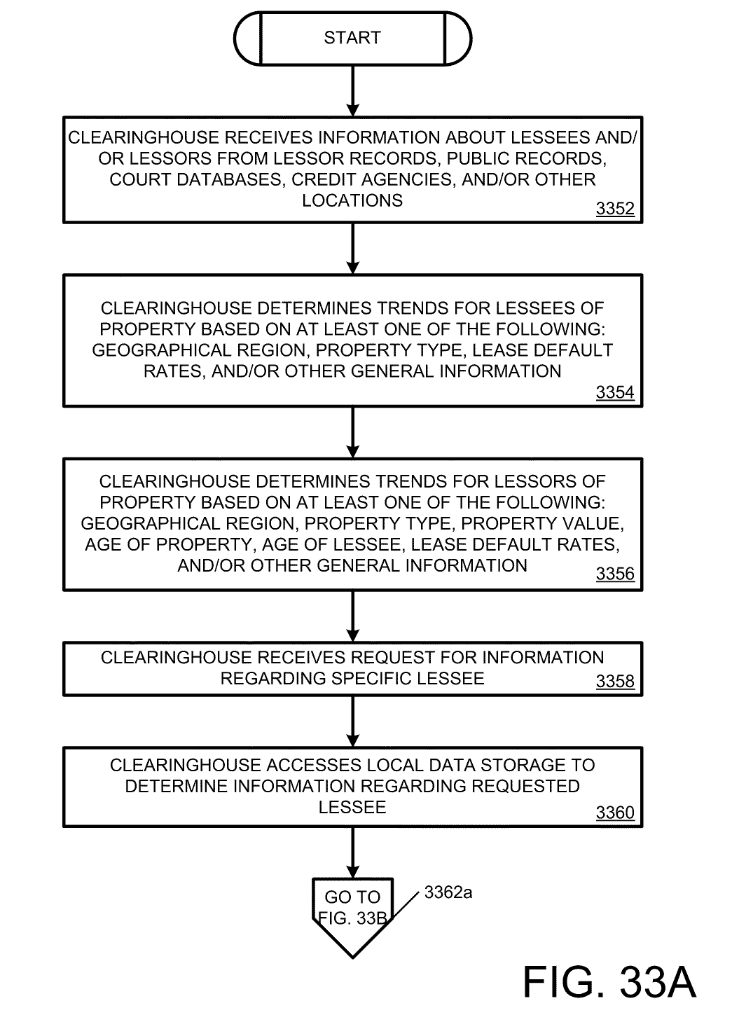

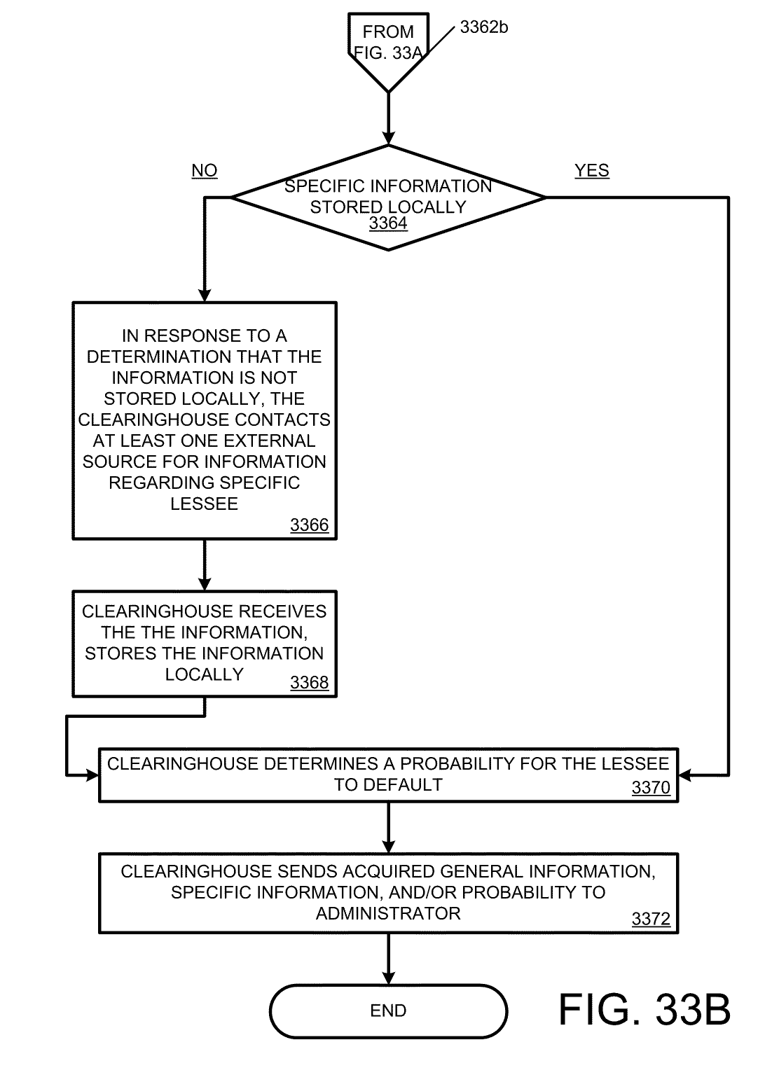

FIGS. 33A and 33B illustrate a nonlimiting example of a process for a clearinghouse to access data for a loss mitigation instrument as requested by a lessee, similar to the process from FIG. 32.

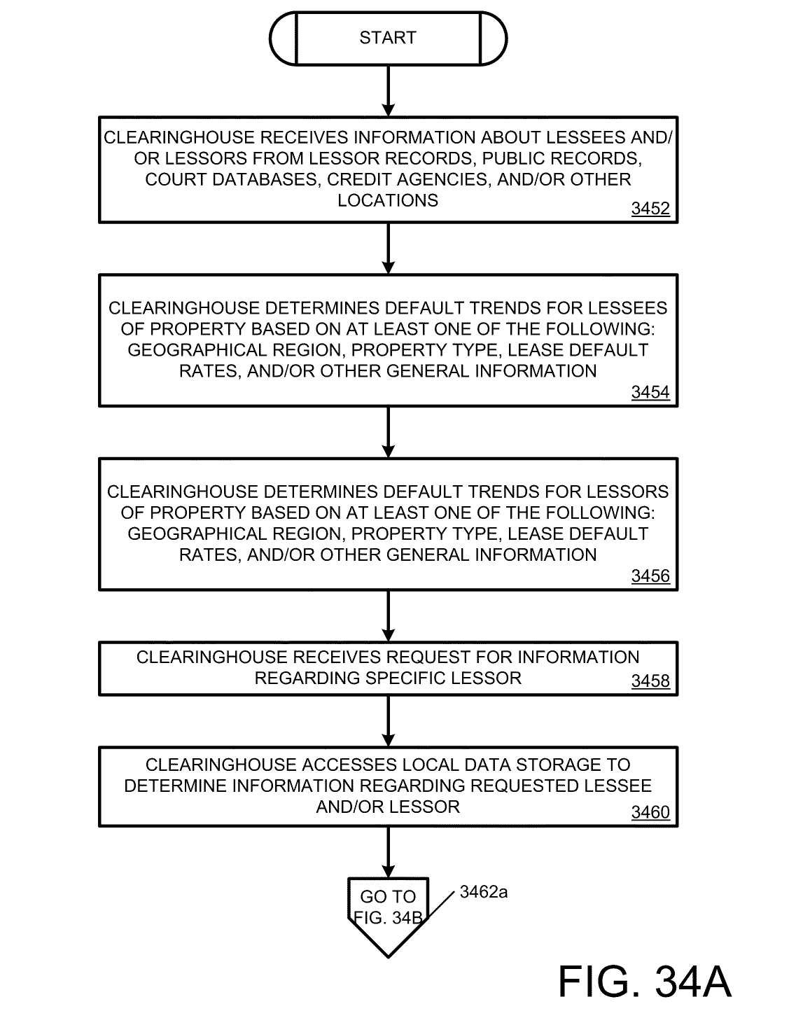

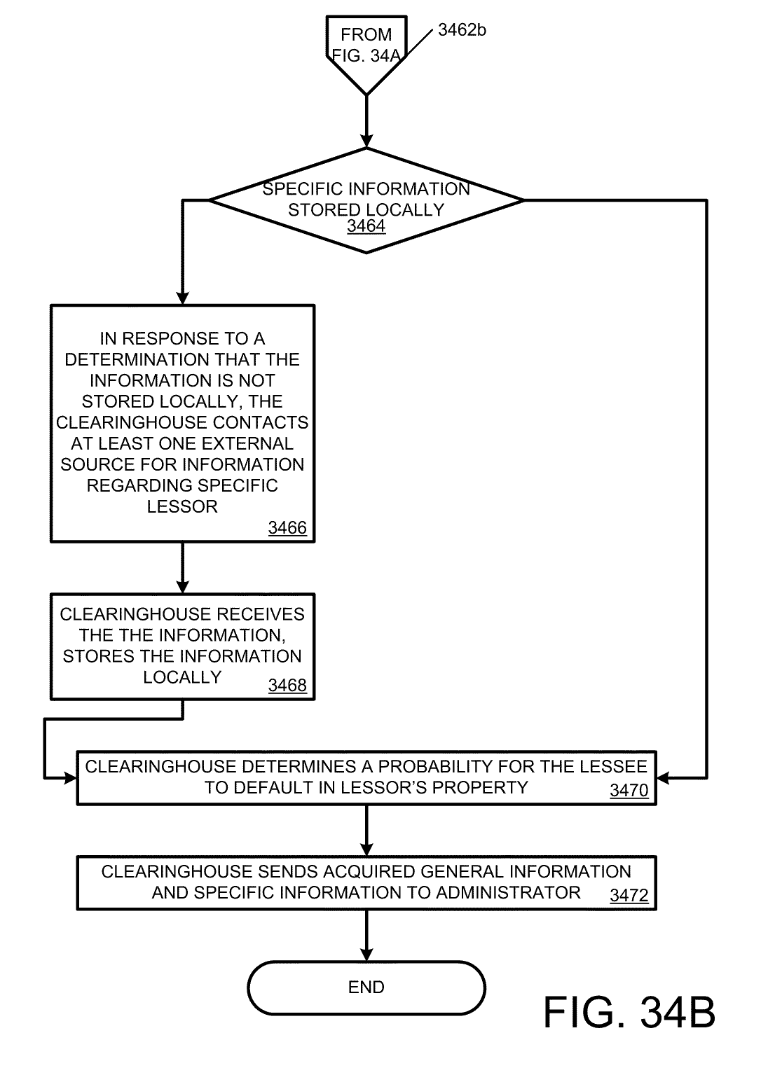

FIGS. 34A and 34B illustrate a nonlimiting example of a process for a clearinghouse to access data for a loss mitigation instrument as requested by a lessor, similar to the process from FIGS. 33A and 33B.

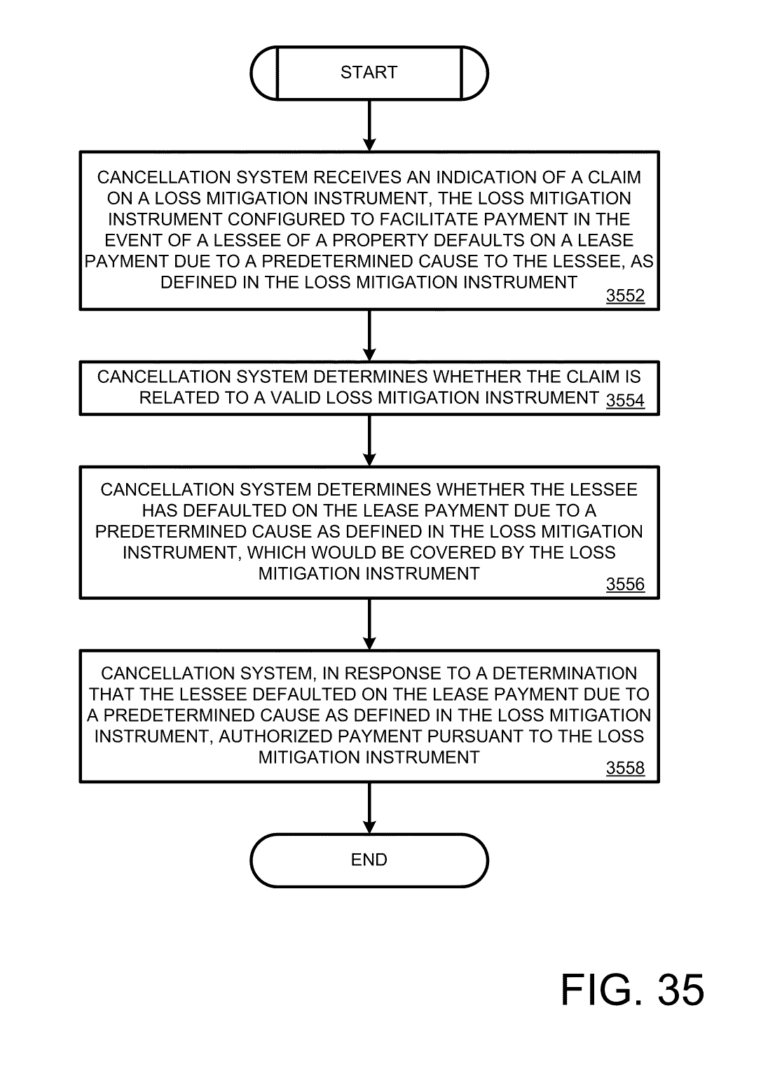

FIG. 35 illustrates a nonlimiting example of a process for processing a claim on a loss mitigation instrument, similar to the process from FIGS. 34A and 34B.

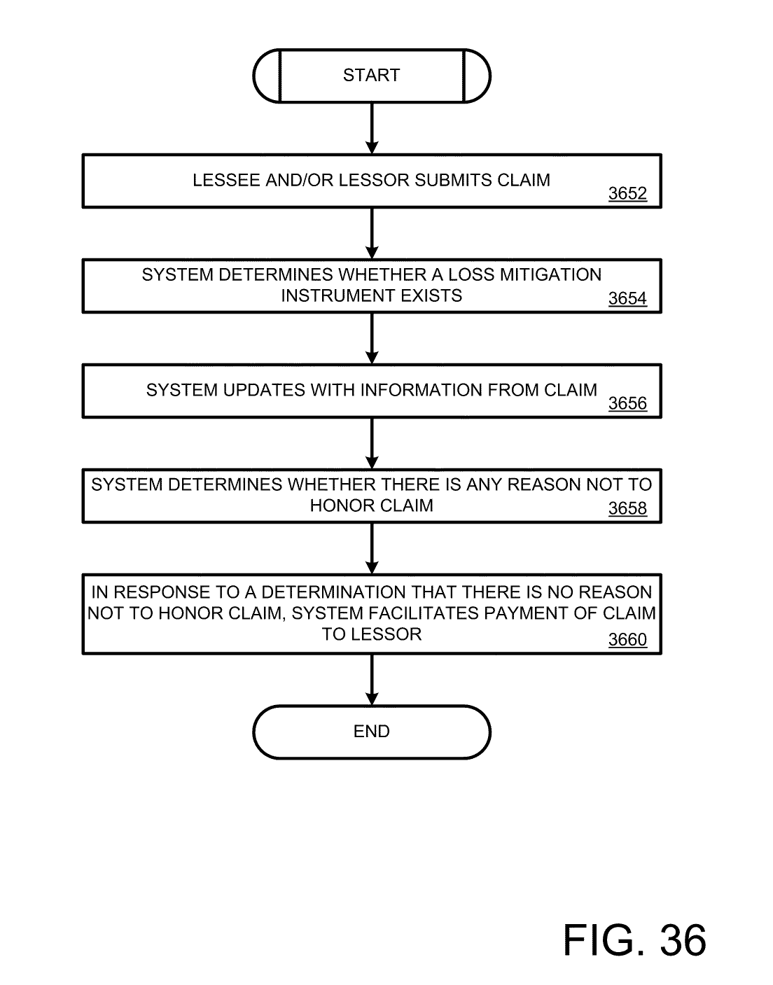

FIG. 36 illustrates a nonlimiting example of a process for facilitating payment of a claim from a loss mitigation instrument, similar to the process from FIGS. 35A and 35B.

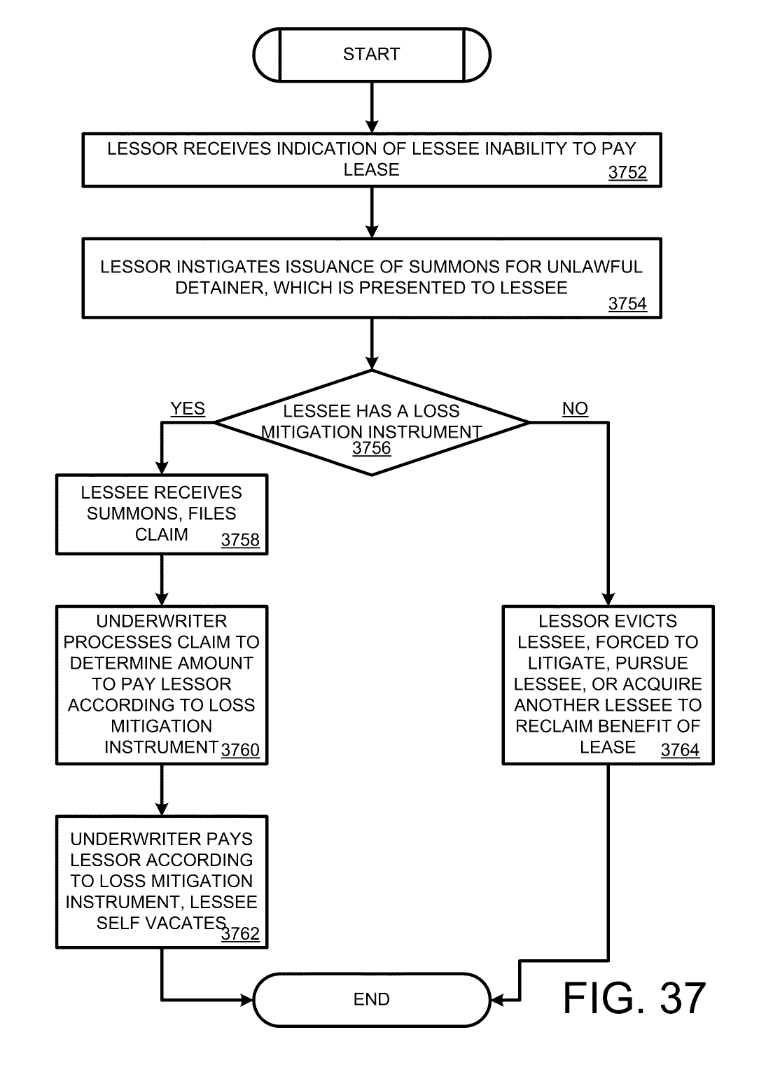

FIG. 37 illustrates a nonlimiting example of a process for implementing a loss mitigation instrument in the case of default by a lessee, similar to the diagram from FIG. 36.

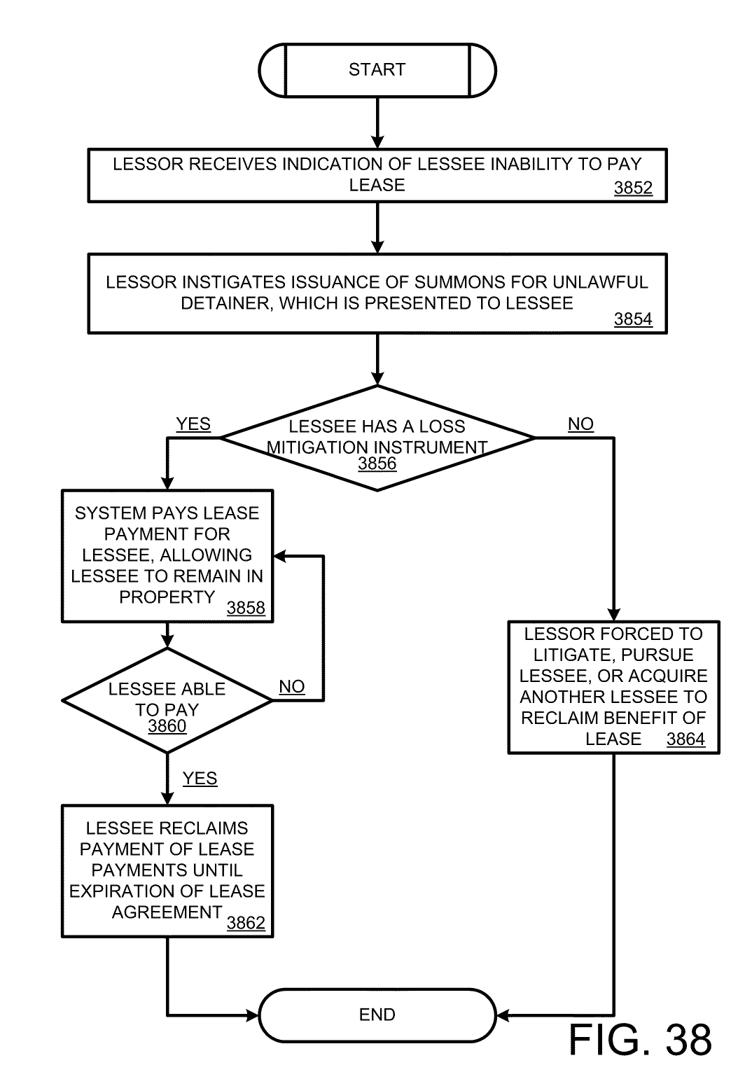

FIG. 38 illustrates a nonlimiting example of a process for implementing a loss mitigation instrument while allowing the lessee to remain in possession of the property, similar to the process from FIG. 37.

### DETAILED DESCRIPTION

Embodiments disclosed herein may be configured for providing and/or implementing a loss mitigation instrument. A loss mitigation instrument may include a document and/or obligations, assets, and/or responsibilities as defined in that document. Further, in some embodiments, causes defined in/by the loss mitigation instrument may include causes described in the loss mitigation instrument itself, incorporated by reference or otherwise associated with the loss mitigation instrument. As a nonlimiting example, at least one embodiment may provide a mechanism for a lessor and/or lessee of property to acquire a loss mitigation instrument to reduce the effect of a default on lease payments by the lessee. The loss mitigation instrument may be acquired by the lessee and/or lessor and may be provided to repay the lessor in case the lessee incurs a financial hardship (such as loss of a job, bankruptcy, etc.) that prevents the lessee from making lease payments. To that end, analysis may be performed to determine a probability of default and thus determine a cost for the loss mitigation instrument.

Similarly, some embodiments disclosed herein may facilitate compilation and analysis of data related to the lessee and/or lessor to determine a probability of default. As a nonlimiting example, a clearinghouse server may be utilized for compiling data regarding categories of lessees and lessors, as well as data specific to a particular lessee and/or lessor. With this information the clearinghouse server may be configured to provide adequate information for determining a cost, likelihood of default, likelihood of moral hazard, and/or other data associated with providing the loss mitigation instrument.

Further, some embodiments may be configured for implementing a loss mitigation instrument to fulfill an underwriter's obligation in the case of default by the lessee. As a nonlimiting example, if a lessee defaults on a lease due to a predetermined acceptable event (such as loss of job, bankruptcy, etc.), a determination may be made regarding if the underwriter will pay and, if so, the amount the underwriter will pay to the lessor to fulfill the loss mitigation instrument.

One should also note that, depending on the particular configuration, the loss mitigation instrument may be crafted according to a particular lease. As a nonlimiting example, if a lease defines that the lease can be ended prior to full term if concessions and two months of lease payments are paid, the loss mitigation instrument may be configured to fulfill that obligation if the lessee defaults with cause within the lease term. This enables the lease to be canceled prior to full term without negative impact to the lessee, while ensuring that the lessor receives adequate restitution to the lease in default. Similarly, in at least one embodiment, the cost and/or benefit provided by the loss mitigation instrument may be configured to adjust in accordance with lease terms, default risk analysis (including lessee and lessor data), and monthly lease payment. The combination of these can result in either a higher or lower cost of the loss mitigation instrument.

Referring now to the drawings, FIG. 1 illustrates a nonlimiting example of a computing environment for providing a loss mitigation instrument. As illustrated in FIG. 1, a computing environment may include a network 100 that facilitates communication with one or more computing devices. While illustrated in FIG. 1 as personal computers, the computing devices of FIG. 1 may be personal computers, servers, wireless devices, and/or other types of computing devices. More specifically, a lessee may utilize a lessee computing device 102 to apply for a loss mitigation instrument. The lessee computing device 102 may communicate with a loss mitigation system 104, which may include an underwriter computing device 104a, a distributor computing device 104b, an administrator computing device 104c, and/or a cancellation system computing device 104d. In some embodiments, the distributor 104b and/or the administrator 104c may include a web server for providing user interfaces, such as those illustrated in FIGS. 3-27. Similarly, a lessor may communicate with the loss mitigation system 104, via a lessor computing device 106. As described in more detail below, the lessor computing device 106 may communicate lessor information and/or lessee information to the loss mitigation system 104. Also included in the nonlimiting example of FIG. 1, is a credit agency 108, a court system 110, a public records computing device 112, and a clearinghouse system 114.

In operation of a nonlimiting example, a lessee may desire to lease property (real property, personal property, commercial property, and/or other types of property) from a lessor. The lessee and lessor may or may not currently have an executed lease contract. Accordingly, the lessee may apply for a loss mitigation instrument by contacting the loss mitigation system 104, such as via the administrator computing device 104c and/or distributor 104b. The lessee computing device102 may contact the loss mitigation system 104 via a web interface, and/or via other techniques. In the web interface embodiment, the lessee computing device 102 may be provided with one or more web pages for providing lessee information, property information, lease information, and/or other information.

Once the loss mitigation system 104 receives the requested information from the lessee computing device 102, the loss mitigation system 104 may query the lessor computing device 106 to determine additional information regarding the lessee, lessor, property, and/or lease. Additionally, the loss mitigation system 104 may contact the credit agency 108, court system 110, public records 112, and/or clearinghouse system 114 for additional information. More specifically, in at least one nonlimiting example the loss mitigation system 104 can acquire data from the credit agency 108 regarding the credit score of the lessee and/or lessor; contact the court system to determine if any judgments have been issued regarding the lessee, lessor, and/or property; and contact public records to determine any other relevant information.

Additionally, the loss mitigation system may also contact the clearinghouse system 114 for additional information. More specifically, the clearinghouse system 114 may be configured to compile general information regarding lessors and/or lessees, as well as information regarding specific lessees and/or lessees. Additionally, while the clearinghouse system 114 may be external to the loss mitigation system 104 (and thus serve other entities in addition to the loss mitigation system 104), in at least one nonlimiting example, the clearinghouse system 114 is part of the loss mitigation system 104.

Regardless, the clearinghouse system 114 may be configured to query one or more different systems to determine general information, such as overall lessee default rates, lessee default rates over particular geographic regions, lessee default rates over particular types of properties, lessee default rates for particular price ranges of properties, average time lessees spend with particular property (overall, based on geographic region, based on type of property, based on value of property, etc.). Similarly, the clearinghouse system 114 may be configured to determine information regarding a specific lessee, lessor, and/or property. More specifically, the clearinghouse system 114 may acquire and store information from the credit agency 108, court system 110, and public records 112. This information may be stored and periodically updated such that future inquiries for loss mitigation instruments by this lessor and/or lessee may be easily accessed by the clearinghouse system 114. Consequently, while in some embodiments the loss mitigation system 104 may contact the credit agency 108, court system 110, public records 112, and clearinghouse system 114 for each request, in at least one nonlimiting example, the clearinghouse system 114 can compile, analyze, and store the data locally such that the loss mitigation system 104 need not necessarily contact the credit agency 108, court system 110, and public records 112 for each request.

Once the information is compiled and analyzed by the administrator computing device 104c, distributor 104b, and/or clearinghouse system 114, the analyzed data may be sent to the underwriter 104a to determine the terms for a loss mitigation instrument for this particular lessee, lessor, and/or property. The underwriter 104a can then send the terms to the administrator computing device 104c, which can send the determined terms to the lessee computing device 102 and/or lessor computing device 106. The lessee and/or lessor can then determine whether the terms are acceptable. If the lessee and/or lessor determine that the terms of the proposed loss mitigation instrument are acceptable, the lessee computing device 102 and/or lessor computing device 106 can indicate as such and begin facilitating payment for a policy (such as for covering loss by a lessor due to default by the lessee) that is represented by the loss mitigation instrument.

Once a loss mitigation instrument is created for a lessee and/or lessor, the lessee and/or lessor may make payments (e.g., annual, monthly, or other scheduled payments) to maintain policy represented by the loss mitigation instrument. In the event of an occurrence that prevents the lessee from paying one or more lease payments, the lessee computing device 102 and/or lessor computing device 106 may submit a claim for fulfillment of the policy related to the loss mitigation instrument. The loss mitigation system 104 may then determine whether the claim is valid and, if so, the amount to pay on the claim.

One should note that while the embodiments described above refer to a situation where a lessee computing device 102 creates the loss mitigation policy, this is a nonlimiting example. More specifically, in at least one nonlimiting example, the lessor computing device 106 may facilitate creation of the policy with our without the lessee's knowledge.

FIG. 2 illustrates a nonlimiting example of a computing device 104c, such as may be utilized in providing and/or fulfilling a loss mitigation instrument such as in the environment from FIG. 1. Although a wire-line device (e.g., the administrator computing device 104c) is illustrated, this discussion can be applied to wireless devices (and/or other devices), as well. According to exemplary embodiments, in terms of hardware architecture, the administrator computing device 104c includes a processor 280, a memory component 282, a display interface 294, data storage 295, one or more input and/or output (I/O) device interfaces 296, and/or one or more network interfaces 298 that are communicatively coupled via a local interface 292. The local interface 292 can include, for example but not limited to, one or more buses and/or other wired or wireless connections. The local interface 292 may have additional elements, which are omitted for simplicity, such as controllers, buffers (caches), drivers, repeaters, and receivers to enable communications.

Further, the local interface 292 may include address, control, and/or data connections to enable appropriate communications among the aforementioned components. The processor 280 may include a device for executing software, particularly software stored in the memory component 282. The processor 280 can include any custom made or commercially available processor, a central processing unit (CPU), an auxiliary processor among several processors associated with the administrator computing device 104c, a semiconductor based microprocessor (in the form of a microchip or chip set), a macroprocessor, and/or generally any device for executing software instructions.

The input/output devices that may be coupled to the system I/O interface(s) 296 may include input devices, for example but not limited to, a keyboard, mouse, scanner, touch screen, microphone, etc. Further, the input/output devices may also include output devices, for example but not limited to, a printer, display, speaker, etc. Additionally, the input/output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more of the network interfaces 298 for facilitating communication with one or more other devices. More specifically, network interface 298 may include any component configured to facilitate a connection with another device. While in some embodiments, among others, the administrator computing device 104c can include the network interface 298 that includes a personal computer memory card international association (PCMCIA) card (also abbreviated as “PC card”) for receiving a wireless network card, this is a nonlimiting example. Other configurations can include the communications hardware within the administrator computing device 104c, such that a wireless network card is unnecessary for communicating wirelessly. Similarly, other embodiments include the network interfaces 298 for communicating via a wired connection. Such interfaces may be configured with universal serial bus (USB) interfaces, serial ports, and/or other interfaces.

The memory component 282 can include any one or combination of volatile memory elements (e.g., random access memory (RAM, such as DRAM, SRAM, SDRAM, etc.)) and/or nonvolatile memory elements (e.g., flash memory, read only memory (ROM), hard drive, tape, CDROM, DVDROM, BluRay™, etc.). Moreover, the memory component 282 may incorporate electronic, magnetic, optical, and/or other types of storage media. One should note that the memory component 282 can have a distributed architecture (where various components are situated remote from one another), but can be accessed by the processor 280.

The software in the memory component 282 may include one or more separate programs, which may include an ordered listing of executable instructions for implementing logical functions. In the example of FIG. 2, the software in the memory component 282 may include risk assessment logic 286, claim processing logic 288, and/or analysis logic 290, as well as an operating system 284. The operating system 284 may be configured to control the execution of other computer programs and provides scheduling, input-output control, file and data management, memory management, and communication control and related services. The risk assessment logic 286 may be configured to facilitate assessing risk of a particular lessee and/or lessor, as well as creating and/or issuing a loss mitigation instrument. Similarly, the claim processing logic may be configured to facilitate analysis of existing policies where a claim has been filed to determine whether a claim should be paid. Further, the analysis logic 290 may be configured to facilitate compilation and analysis of data for determining probabilities related to a loss mitigation instrument, as well as analyze default data to rate properties, groups of properties, as well as build a database for storage of data.

In at least one embodiment, the logic described with regard to FIG. 2 may be configured as a system component and/or module embodied as software and may also be construed as a source program, executable program (object code), script, and/or any other entity that includes a set of instructions to be performed. When constructed as source programs, the logic may be translated via a compiler, assembler, interpreter, or the like (which may or may not be included within the memory component 282) so as to operate properly in connection with the operating system 284.

If the administrator computing device 104c includes a personal computer, workstation, or the like, the software in the memory component 282 may further include a basic input output system (BIOS) (omitted for simplicity). The BIOS is a set of software routines that initialize and test hardware at startup, start the operating system 284, and support the transfer of data among the hardware devices. The BIOS is stored in ROM so that the BIOS can be executed when the administrator computing device 104c is activated.

When the administrator computing device 104c is in operation, the processor 280 may be configured to execute software stored within the memory component 282, to communicate data to and from the memory component 282, and to generally control operations of the administrator computing device 104c pursuant to the software. Software in the memory component 282, in whole or in part, may be read by the processor 280, perhaps buffered within the processor 280, and then executed.

One should also note that while the description with respect to FIG. 2 includes the administrator computing device 104c as a single component, this is a nonlimiting example. More specifically, in at least one exemplary embodiment, the administrator computing device 104c can include a plurality of servers, personal computers, telephones, and/or other devices. Similarly, while the description of FIG. 2 describes the administrator computing device 104c as including all of the risk assessment logic 286, claim processing logic 288, and analysis logic 290; this is also a nonlimiting example illustrated for simplicity. More specifically, in at least one embodiment, the administrator may include at least a portion of the risk assessment logic 286, while the cancellation system 104d includes the claim processing logic 288. Similarly, the clearinghouse system 114 may include the analysis logic 290. Further, other components of FIG. 1 may include a similar architecture and/or logic. Other permutations are also considered to be within the scope of this disclosure.

Additionally, while the risk assessment logic 286, the claim processing logic 288, and the analysis logic 290 are each illustrated in FIG. 2 as single software components; this is also a nonlimiting example. In at least one embodiment, the risk assessment logic 286, the claim processing logic 288, and the analysis logic 290 may each include one or more components, embodied in software, hardware, and/or firmware. Additionally, while the risk assessment logic 286, the claim processing logic 288, and the analysis logic 290 are each depicted as residing on a single device, such as the administrator computing device 104c, the risk assessment logic 286, the claim processing logic 288, and the analysis logic 290 may each reside on one or more devices located in one or more locations.

FIG. 3 illustrates a nonlimiting example of a user interface for providing options related to a loss mitigation instrument, such as may be provided by the computing device from FIG. 2. As discussed above, the administrator computing device 104 (and/or other component) may provide lessee computing device 102 and/or lessor computing device 106 with the user interface of FIG. 3 for creating and/or managing a loss mitigation instrument. As illustrated, the interface of FIG. 3 includes a plurality of options depending on the type of property. More specifically, FIG. 3 illustrates a residential property coverage option 332, a passenger vehicle coverage option 334, a fleet coverage option 336, a watercraft coverage option 338, a commercial coverage option 340, a commercial vehicle coverage option 342, an equipment coverage option 344, and an aircraft coverage option 346. Other options in FIG. 3 include a my coverage option 348, an appreciating asset coverage option 350, a depreciating asset coverage option 352, a lessors option 354, a property managers option 356, a residential tenants option 358, and a commercial tenants option 360. Similarly, some embodiments may be configured to provide one or more dedicated interfaces that only provide for one type of property coverage.

In operation, the options 332-346 provide a user the ability to complete a loss mitigation instrument application for each of the types of property listed and/or other appreciating or depreciating leased assets. As described above, the loss mitigation instrument may be created by a lessee for the lessee, by a lessor for the lessor, and/or by a lessor for a lessee. Similarly, while the loss mitigation instrument may be created for a current lessee and/or lessor, some embodiments may be configured to provide a loss mitigation instrument prior to two or more parties entering a lease agreement.

Additionally included in the nonlimiting example of FIG. 3 is the my coverage option 348. As described in more detail, below, the my coverage option 348 may be configured to allow the user (lessee and/or lessor) to access information regarding a pending and/or existing loss mitigation instrument. The appreciating asset coverage option 350 and depreciating asset coverage 352 option may be configured to provide general coverage information regarding loss mitigation coverage for each type of property. Similarly, the options 354-360 may be configured to provide general information regarding each of the types of entities listed.

FIG. 4 illustrates a nonlimiting example user interface for providing a loss mitigation instrument application, similar to the user interface from FIG. 3. As illustrated in FIG. 4, a residential application for a loss mitigation instrument may include providing a form for a lessee and/or lessor to input the tenant's name, social security number, date of birth, contact information, rental property address, the property management company at that address, monthly rent, lease term, and concession. Upon inputting the information for the residential application, the user may select a submit option 432 to submit the application to the loss mitigation system 104 for processing. Additionally included in the nonlimiting example of FIG. 4 is a declaration. The declaration may include terms for covered termination conditions and/or other legal details for creating a binding contract between the lessee and lessor (and/or other party).

One should note that in at least one embodiment, the form of FIG. 4 may include options in a different format than those illustrated. More specifically, some embodiments may be configured with one or more drop down menu options and/or selectable buttons. Similarly, some embodiments may be configured with other options.

FIG. 5 illustrates a nonlimiting example embodiment of a user interface for confirming receipt of a loss mitigation instrument application, such as the loss mitigation instrument application from FIG. 4. As illustrated in the nonlimiting example of FIG. 5, in response to selecting the submit option 432 (from FIG. 4), the user is provided with a confirmation page indicating that the application was received and that approval (or disapproval) will be provided shortly.

FIG. 6 illustrates a nonlimiting example of a user interface for confirming information submitted via the interface from FIG. 4. As illustrated in the nonlimiting example of FIG. 6, an email may be sent to the email address indicated in the application from FIG. 4. The email may include the information input by the user, as well as an indication that the application is currently being processed. Additionally, one or more options may be provided for accessing the web interface in the event the user desires to edit and/or delete an application, similar to option 2532 in FIG. 25, described in more detail below. Similarly, if no email address is indicated, other techniques for contacting the applicant may be employed.

FIG. 7 illustrated a nonlimiting example of a user interface for providing a fair Isaac Company (FICO) score for the applicant illustrated in FIG. 6. As illustrated in the nonlimiting example of FIG. 7, the user may be provided with an email message indicating a FICO score that was determined by the loss mitigation system 104 and/or clearinghouse system 114 in analyzing the user's application (e.g., by contacting the credit agency 108).

FIG. 8 illustrates a nonlimiting example of a user interface for illustrating acceptance of the application, such as the interface from FIG. 4. As illustrated in the nonlimiting example of FIG. 8, an email may be sent to the user who applied for the loss mitigation instrument. After analyzing and/or processing the received application, the loss mitigation system 104 can send the email of FIG. 8, with a link to a web page and/or an attachment indicating the details of the loss mitigation instrument to which the user qualified.

FIG. 9 illustrates a nonlimiting example of a user interface for providing a commercial application for a loss mitigation instrument, similar to the application illustrated in FIG. 4. More specifically, in response to selection of the commercial coverage option 340 from FIG. 3, the user may be provided with a commercial application, as illustrated in FIG. 9. While the application of FIG. 9 may be similar to the application of FIG. 4, this is a nonlimiting example. In at least one embodiment, the commercial application of FIG. 9 requests a tenant business name, a business owner name, a tenants “doing business as” (DBA) name, a tenant employer identification numbers (EIN), a date of formation, an annual revenue, and a price per square foot, which may differ from the application from FIG. 4. Additionally, a submit option 932 may also be included. Other options may also be provided.

FIG. 10 illustrates a nonlimiting example of a user interface for indicating that a commercial loss mitigation instrument application is received, similar to the interface from FIG. 5. As illustrated in the nonlimiting example of FIG. 10, in response to selecting the submit option 932, the user is provided with a confirmation page indicating that the application was received and that approval (or disapproval) will be provided shortly.

FIG. 11 illustrates a nonlimiting example of a user interface for confirming information submitted via the interface from FIG. 6. As illustrated in the nonlimiting example of FIG. 11, an email may be sent to the email address indicated in the application from FIG. 9. The email may include the information input by the user, as well as an indication that the application is currently being processed. Additionally, one or more options may be provided for accessing the web interface in the event the user desires to edit and/or delete an application.

FIG. 12 illustrates a nonlimiting example of a user interface for indicating Dunn and Bradstreet (D&B) ratings and a Paydex score, similar to the interface from FIG. 7. As illustrated in the nonlimiting example of FIG. 12, the user may be provided with an email message indicating a 3-month D&B paydex rating, and a 12-month D&B paydex rating that were determined by the loss mitigation system 104 and/or clearinghouse system 114 in analyzing the user's application.

FIG. 13 illustrates a nonlimiting example of a user interface for indicating that a commercial loss mitigation instrument application is accepted, similar to the interface from FIG. 8. As illustrated in the nonlimiting example of FIG. 13, an email may be sent to the user who applied for the loss mitigation instrument. After analyzing and/or processing the received application, the loss mitigation system 104 can send the email of FIG. 13, with a link to a web page indicating the details of the loss mitigation instrument to which the user qualified.

FIG. 14 illustrates a nonlimiting example of a user interface for providing a passenger vehicle loss mitigation instrument application, similar to the interface from FIG. 9. As illustrated in FIG. 14, in response to selection of the passenger vehicle option 334, a passenger vehicle application may be provided. More specifically, the passenger vehicle application for a loss mitigation instrument may include providing a form for a lessee and/or lessor to input the lessee name, social security number, contact information, type of vehicle, make and model of vehicle, vehicle identification number (VIN), monthly lease payment, and lease term. Upon inputting the information for the residential application, the user may select the submit option 1432 to submit the application to the loss mitigation system 104.

FIG. 15 illustrates a nonlimiting example of a user interface for indicating that a passenger vehicle loss mitigation instrument application is submitted, similar to the diagram from FIG. 10. As illustrated in the nonlimiting example of FIG. 15, in response to selecting the submit option 1432, the user is provided with a confirmation page indicating that the application was received and that approval (or disapproval) will be provided shortly.

FIG. 16 illustrates a nonlimiting example of a user interface for confirming information submitted via the interface from FIG. 11. As illustrated in the nonlimiting example of FIG. 16, an email may be sent to the email address indicated in the application from FIG. 14. The email may include the information input by the user, as well as an indication that the application is currently being processed. Additionally, one or more options may be provided for accessing the web interface in the event the user desires to edit and/or delete an application.

FIG. 17 illustrates a nonlimiting example of a user interface for indicating a FICO score of an applicant, similar to the interface from FIG. 7. As illustrated in the nonlimiting example of FIG. 17, the user may be provided with an email message indicating a FICO score that was determined by the loss mitigation system 104 and/or clearinghouse system 114 in analyzing the user's application.

FIG. 18 illustrates a nonlimiting example of a user interface for indicating that a passenger vehicle loss mitigation instrument application is accepted, similar to the interface from FIG. 13. As illustrated in the nonlimiting example of FIG. 18, an email may be sent to the user who applied for the loss mitigation instrument. After analyzing and/or processing the received application, the loss mitigation system 104 can send the email of FIG. 18, with a link to a web page indicating the details of the loss mitigation instrument to which the user qualified.

FIG. 19 illustrates a nonlimiting example of a user interface for providing a commercial vehicle loss mitigation instrument application, similar to the interface from FIG. 14. More specifically, in response to selection of the commercial vehicle coverage option 342 from FIG. 3, the user may be provided with a commercial application, as illustrated in FIG. 19. While the application of FIG. 19 may be similar to the application of FIG. 9, this is a nonlimiting example. In at least one embodiment, the commercial application of FIG. 9 requests a tenant business name, a business owner name, a tenants “doing business as” (DBA) name, a tenant employer identification numbers (EIN), a date of formation, an annual revenue, and a price per square foot, which may differ from the application from FIG. 4. Additionally, a submit option 932 may also be included. Other options may also be provided.

FIG. 20 illustrates a nonlimiting example of a user interface for indicating that a commercial vehicle loss mitigation instrument application is submitted, similar to the diagram from FIG. 15. As illustrated in the nonlimiting example of FIG. 20, in response to selecting the submit option 1932, the user is provided with a confirmation page indicating that the application was received and that approval (or disapproval) will be provided shortly.

FIG. 21 illustrates a nonlimiting example of a user interface for confirming information submitted via the interface from FIG. 16. As illustrated in the nonlimiting example of FIG. 21, an email may be sent to the email address indicated in the application from FIG. 19. The email may include the information input by the user, as well as an indication that the application is currently being processed. Additionally, one or more options may be provided for accessing the web interface in the event the user desires to edit and/or delete an application.

FIG. 22 illustrates a nonlimiting example of a user interface for indicating Dunn and Bradstreet (D&B) ratings and a Paydex score, similar to the interface from FIG. 12. As illustrated in the nonlimiting example of FIG. 22, the user may be provided with an email message indicating a 3-month D&B paydex rating, and a 12-month D&B paydex rating that were determined by the loss mitigation system 104 and/or clearinghouse system 114 in analyzing the user's application.

FIG. 23 illustrates a nonlimiting example of a user interface for indicating that a commercial vehicle loss mitigation instrument application is accepted, similar to the interface from FIG. 18. As illustrated in the nonlimiting example of FIG. 23, an email may be sent to the user who applied for the loss mitigation instrument. After analyzing and/or processing the received application, the loss mitigation system 104 can send the email of FIG. 18, with a link to a web page indicating the details of the loss mitigation instrument to which the user qualified.

One should note that, while not explicitly illustrated in the drawings, similar interfaces may be provided for options 336, 338, 344, and 346, from FIG. 3. More specifically, similar criteria may be requested and/or submitted for fleet coverage, equipment coverage, watercraft coverage, aircraft coverage, and/or coverage for other leased assets.

FIG. 24 illustrates a nonlimiting example of a user interface for accessing an account of the loss mitigation system, as may be accessed from the interface in FIG. 3. As illustrated in the nonlimiting example of FIG. 24, a user (e.g., a lessee and/or lessor) may login to the loss mitigation system 104 by authenticating their identity. As a nonlimiting a user identifier and/or a password may be stored by the administrator computing device 140c. Further, the interface of FIG. 24 may be accessed via selection of the my coverage option 348 (FIG. 3); however, this is not a requirement.

FIG. 25 illustrates a nonlimiting example of a user interface for showing account information, in response to a successful authentication, as may be accessed from the interface from FIG. 24. As illustrated in the nonlimiting example of FIG. 25, information regarding the loss mitigation instrument that was acquired by the lessee and/or lessor is provided. This information may include an account number, a property type, a lease term, a monthly rent payment, a loss mitigation instrument price, a listing of other users that are authorized to access the account, a property address (for real property; other types of property could include different information), the coverage of the loss mitigation instrument (e.g., what triggers payment of a claim), and available payment in the event of default. Also included in the nonlimiting example of FIG. 25 are an edit information option 2532 and a file a claim option 2534.

In response to selection of the edit information option 2532, the user may be provided with one or more options to edit the information provided in FIG. 25 (and/or other information). While the user can manually edit this information (such as type of property, etc.), some information may be automatically edited, in response to a user command. As a nonlimiting example, if the user's FICO score has changed, the user may indicate this fact, and the loss mitigation system 104 can contact the appropriate entity to verify this change. This allows the user to benefit if his/her FICO score improves. Similarly, if the user indicates that the rent amount has changed, the loss mitigation system 104 can contact the lessor to verify. By changing rent, the cost of the loss mitigation instrument may change due to the change in obligation to underwrite the loss mitigation instrument.

FIG. 26 illustrates a nonlimiting example of a user interface for filing a claim on an existing loss mitigation instrument, similar to the interface from FIG. 25. As illustrated in the nonlimiting example of FIG. 26, the user can select one or more options to begin the claims process. More specifically, the user may select the reason that a claim needs to be filed, a current status of the property, whether legal action has been taken, whether the lessor (or lessee) is the claimant (entity filing the claim), whether there is currently damage to the property, and whether there is other information that might be pertinent to the claim. Upon submission of the claim for (e.g., via selection of a submit option 2632), the loss mitigation system 104 can begin determining whether this is a valid claim and, if so, the amount due for payment.

More specifically, the loss mitigation system 104 can access the court system 110, the lessor, and/or other entity to determine whether there is a valid claim. As a nonlimiting example, if a lessee submits a claim, the loss mitigation system 104 can contact the lessor (and/or court system 110) to determine whether the lease agreement has been violated as covered by the loss mitigation instrument. If, so, the loss mitigation system 104 can contact the court system 110, employer, and/or other entity to determine whether the default occurred due to a predetermined covered cause (e.g., loss of job, bankruptcy, divorce, etc.), if so, the loss mitigation system 104 can begin fulfillment of the claim.

FIG. 27 illustrates a nonlimiting example of a user interface for providing intuitive information to a user, similar to the interface from FIG. 3. As illustrated in the nonlimiting example of FIG. 27, upon logging into the loss mitigation system 104 (e.g., via the interface from FIG. 24), the loss mitigation system 104 can determine the current status of the lease. This information may be determined in any of a plurality of different ways, including the loss mitigation system 104 receive information from one or more bank accounts of the lessee and/or lessor to determine whether a payment was sent and/or received. Similarly, some embodiments may be configured such that the lessor computing device 106 automatically contacts the loss mitigation system 104 in the event of a payment (and/or nonpayment).

Regardless, if a payment has not been received, the interface in FIG. 27 can indicate the lateness (e.g., number of days late) of the payment and provide an option 2732 to make a claim, an option to not make a claim 2734, and/or an option to authorize payment of the lease at this time 2736. In response to selection of the make a payment option 2736, the loss mitigation system 104 can direct the user to an appropriate destination for making a payment (e.g., to a payment authorization interface). Similarly, in some embodiments, the loss mitigation can automatically authorize payment for the lessee to the lessor.

FIG. 28 illustrates a nonlimiting example of a process for creating a loss mitigation instrument, such as in the environment of FIG. 1. As illustrated in the nonlimiting example of FIG. 28, the loss mitigation system 104 can provide an interface for a party to a lease (e.g., the lessee and/or the lessor) of property to apply for a loss mitigation instrument (block 2852). The loss mitigation system 104 can receive information from the party to the lease regarding the lessee and the property (block 2854). The loss mitigation system 104 can determine terms for the loss mitigation instrument based on the received information, where the loss mitigation instrument is configured to provide for payment of a claim for default on a lease by the lessee, where default results from a predetermined cause to the lessee, as defined in the loss mitigation instrument (block 2856). The loss mitigation system 104 can provide the loss mitigation instrument to the party to the lease (block 2858).

As a nonlimiting example the terms for the loss mitigation instrument may be determined via an automatic analysis by the loss mitigation system 104 (e.g., via the administrator computing device 104c and/or the underwriter 104a) of the lease agreement and risk analysis, as discussed above. Similarly, in some embodiments a user may manually enter and/or determine terms for the loss mitigation instrument.

FIG. 29 illustrates a nonlimiting example of a process that may be utilized for initiating a loss mitigation instrument, such as in the environment from FIG. 28. As illustrated in the nonlimiting example of FIG. 29, the distributor 104b can receive a request for a loss mitigation instrument from a lessor computing device 106, where the request includes applicant information and property information (block 2952). As described above, the applicant may be a lessor for opening a loss mitigation instrument for one or more lessees (or potential lessees). Accordingly, the lessor can submit information regarding the property, as well as information regarding a particular lessee (or potential lessee). This data may be analyzed via the loss mitigation system 104 and/or the clearinghouse system 114.

One should note that while in some embodiments the application may be for a loss mitigation instrument covering a single lessee, in at least one nonlimiting example, the lessor can create an multiple property loss mitigation instrument that covers a plurality of properties/lessees. In such a scenario, the lease cancellation system 104 could analyze default rates of prior lessees of the properties and/or other default rate trends to determine data (such as probability data) regarding the requested multiple property loss mitigation instrument. Similarly, if there are lessees currently utilizing the lessor's property, those lessees may be considered, even if other properties are currently unutilized.

Regardless, the distributor 104b can send at least a portion of the received (and/or analyzed) data to the underwriter 104a (block 2954). The underwriter 104a may receive the information and determine whether to underwrite the loss mitigation instrument for the applicant (block 2956). The underwriter 104a may then inform the distributor 104b regarding whether the underwriter 104a will underwrite the loss mitigation and, if so, informs the distributor 104b regarding the terms of the loss mitigation instrument that has been approved (block 2958). The distributor 104b can then inform the lessor computing device 106 of the loss mitigation instrument terms and may begin receiving payments from the lessor.

FIG. 30 illustrates another nonlimiting example of a process that may be utilized for initiating and/or administrating a loss mitigation instrument, similar to the process from FIG. 29. As illustrated in the nonlimiting example of FIG. 30, the distributor 104b can receive lessee information regarding a loss mitigation instrument (block 3052). As discussed above, as either the lessee or the lessor (or both) may acquire a loss mitigation instrument, the lessee data may be received from the lessee, the lessor, or both. Regardless, the distributor 104b can send lessee data to the administrator computing device 104c (block 3054). The administrator computing device 104c can receive the lessee data, and determine lessor data (block 3056). As also described above, the lessor data can be determined by querying the lessor computing device 106, by contacting a clearinghouse system 114, and/or via other techniques, which may also facilitate analysis of the data to determine a likelihood of default.

The administrator computing device 104c can send the lessee data and lessor data to the underwriter 104a (block 3058). The underwriter 104a can receive the data and determine terms for one or more available loss mitigation instruments (block 3060). The underwriter 104a can send the terms of the available loss mitigation instruments to the administrator computing device 104c (block 3062). The administrator computing device 104c can receive the terms, indicate the terms to lessor computing device 106, and send terms to lessee computing device 102 (block 3064). In some embodiments, the distributor 104b can receive the terms and send the terms to the lessee computing device 102 (block 3066). The distributor 104b may also begin receiving payment from the lessee (block 3068).

FIG. 31 illustrates a nonlimiting example of a process for analyzing lease default data, similar to the process from FIG. 30. As illustrated in the nonlimiting example of FIG. 31, the clearinghouse system 114 can receive information regarding a loss mitigation instrument application for a loss mitigation instrument. The loss mitigation instrument may be configured to facilitate payment in the event a lessee of a loss mitigation instrument application defaults on a lease payment due to an unexpected financial hardship or other predetermined cause, as defined in the loss mitigation instrument (block 3152). Additionally, the clearinghouse system 114 can receive general data regarding lessees and lessors to determine at least one piece of lease default information, such as a default trend (block 3154). As discussed above, the clearinghouse system 114 can receive the general data from public records, credit agencies, court systems, and/or from other places. The clearinghouse system can receive specific data regarding the lessee (block 3156). The clearinghouse system 114 may also determine from the at least one lease default trend and the specific historical data regarding the lessee, a likelihood of the lessee defaulting on the lease, where the likelihood is utilized to determine whether the loss mitigation instrument is accepted and, if the loss mitigation instrument application is accepted, at least one term of the loss mitigation instrument (block 3158).

FIG. 32 illustrates a nonlimiting example of a process for utilizing a clearinghouse in initiating and/or administrating a loss mitigation instrument, similar to the process from FIG. 31. As illustrated in the nonlimiting example of FIG. 32, the distributor 104b receives lessee data regarding a loss mitigation instrument (block 3252). As discussed above, the data may be received from the lessee computing device 102 and/or the lessor computing device 106. The distributor 104b can send the received lessee data to the administrator computing device 104c (block 3254). The administrator computing device 104c can receive the lessee data and contact the clearinghouse system 114 for additional lessee data and/or lessor data (block 3256). The administrator computing device 104c can receive the requested data from the clearinghouse system 114; can analyze the received data to determine default probabilities, and at least a portion of the probability data, the lessee data, and/or the lessor data to the underwriter 104a (block 3258). The underwriter 104a can determine whether a loss mitigation instrument is available and, if so can determine terms of one or more available loss mitigation instruments (block 3260). The underwriter 104a can send the determined terms to the administrator computing device 104c (block 3262). The administrator computing device 104c can receive the terms, indicate the terms to the lessor computing device 106, and send terms to distributor 104b (block 3264). The distributor 104b can receive the terms and send the terms to the lessee computing device 102 (block 3266). The distributor 104b can also begin receiving payment on the loss mitigation instrument from the lessee (block 3268).

FIGS. 33A and 33B illustrate a nonlimiting example of a process for a clearinghouse to access data for a loss mitigation instrument as requested by a lessee, similar to the process from FIG. 32. As illustrated in the nonlimiting example of FIG. 33A, the clearinghouse system 114 can receive information about lessees and/or lessors from lessor records, public records, court databases, credit agencies, and/or other locations (block 3352). More specifically, the clearinghouse system 114 can access information regarding a plurality of different lessors, lessees, and/or others to determine general trends regarding default rates across lessor portfolio, geographic regions, etc.

As a nonlimiting example, the clearinghouse system 114 can determine trends for lessees based on at least one of the following: geographical region, property type, lessee credit score, lessee default history, lessor claim history, and/or other general information (block 3354). Similarly, the clearinghouse system 114 can determine trends for lessors of property, based on at least one of the following: geographical region of the property, property type, lessee credit score, lessee default history, lessor claim history and/or other general information (block 3356). The clearinghouse system 114 may additionally receive a request for information regarding a specific lessee (block 3358). The request may be a result of an application for a loss mitigation instrument; however, this is not a requirement. The clearinghouse system 114 can access local data storage to determine information regarding the requested lessee (block 3360). The general trends may be determined based on geographic location of the lessee, geographic location of the property, lease default rate of the property, income of the lessee, income of the property, value of the property, number of units on the property, and/or other information. The process may then proceed to jump block 3362, continued in FIG. 33B.

FIG. 33B is a continuation of the process from FIG. 33A. More specifically, from jump block 3362b, a determination can be made regarding whether specific information about the lessee and/or lessor is stored locally (block 3364). If so, the process proceeds to block 2870. If not, the clearinghouse system 114 can contact at least one external source for information regarding the specific lessee (block 3366). More specifically, now that the clearinghouse system 114 has acquired the identity of a specific lessee, a specific request can be made for information on the lessee, property and/or other specific information that is pertinent to the lessee. The clearinghouse system 114 can receive the information and store the information locally (block 3378). The clearinghouse system 114 can then determine a probability for the lessee to default (block 3370). The clearinghouse system 114 may additionally send the acquired general information, the acquired specific information and/or the determined probabilities to the administrator computing device 104c (block 3372).

One should note that while some embodiments are configured for the administrator computing device 104c and/or underwriter 104a to determine default and/or other probabilities, this is a nonlimiting example. As illustrated in block 3370, the clearinghouse system 114 may be configured to determine probabilities related to the loss mitigation instrument (e.g., a probability of the lessee defaulting). Similarly, while FIG. 33B illustrates that default probabilities may be determined, other probabilities may also be determined, such as probability lessee will lose his/her job, probability of lessee causing damage to the property and/or other probabilities.

FIGS. 34A and 34B illustrate a nonlimiting example of a process for the clearinghouse system 114 to access data for a loss mitigation instrument as requested by the lessor computing device, similar to the process from FIGS. 31A and 31B. As illustrated in the nonlimiting example of FIG. 34A, the clearinghouse system 114 can receive information regarding lessees and/or lessors from lessor records, public records, court databases, credit agencies, and/or other locations (block 3452). The clearinghouse system 114 can also determine general trends (e.g., default trends) for lessees of property, based on at least one of the following: geographical region, property type, property value, age of property, age of lessee, and/or other general information (block 3454). The clearinghouse system 114 can also determine general trends for lessors of property based on at least one of the following: geographical region, property type, property value, age of property, age of lessee, and/or other general information (block 3456). The clearinghouse system 114 can also receive a request for information regarding a specific lessor (block 3458). The clearinghouse system 114 can assess local data storage to determine information regarding the requested lessee and/or lessor (block 3460). The flowchart can then proceed to block 3462a, continued in FIG. 34B.

FIG. 34B is a continuation of the flowchart from FIG. 34A. More specifically, from jump block 3462b, a determination can be made regarding whether any specific information is stored locally (block 3464). If so, the process proceeds to jump block 3470. If not, the clearinghouse contacts at least one external source for information regarding the specific lessor (block 3466). The clearinghouse system 114 can receive the information and store the information locally (block 3468). The clearinghouse system 114 may additionally determine a probability for the lessee to default in payments on lessor's property (block 3470). The clearinghouse can send acquired general information, specific information, and probability data to the administrator computing device 104c.

FIG. 35 illustrates a nonlimiting example of a process for processing a claim on a loss mitigation instrument, similar to the process from FIGS. 34A and 34B. As illustrated in the nonlimiting example of FIG. 35, the cancellation system 104d can receive an indication of a claim on a loss mitigation instrument, the loss mitigation instrument being configured to facilitate payment in the event of a lessee of a property defaults on a lease payment due to unexpected financial hardship to the lessee or other predetermined cause as defined in the loss mitigation instrument (block 3552). The cancellation system 104d may determine whether the claim is related to a valid loss mitigation instrument (block 3554). The cancellation system 104d can determine whether the lessee has defaulted on the lease payment due to unexpected financial hardship or other predetermined cause as defined in the loss mitigation instrument, which would be covered by the loss mitigation instrument (block 3556). Additionally, the cancellation system 104d can, in response to a determination that the lessee defaulted on the lease payment due to an unexpected financial hardship or other predetermined cause as defined in the loss mitigation instrument, authorized payment pursuant to the loss mitigation instrument (block 3560).

Similarly, in some embodiments, in response to a determination that the default is not covered (or there is no default), the administrator computing device 104c can send an indication to the lessee and/or lessor. Further, if a potential for fraud is detected, a report may be filed with an appropriate criminal agency.

FIG. 36 illustrates a nonlimiting example of a process for facilitating payment of a claim from a loss mitigation instrument, similar to the process from FIGS. 32A and 32B. As illustrated in the nonlimiting example of FIG. 36, the lessee and/or lessor can submit a claim on a loss mitigation instrument (block 3652). The cancellation system 104d can determine whether a loss mitigation instrument exists for this lessee and/or lessor (block 3654). The cancellation system 104d can update itself with information from the received claim (block 3656).

More specifically, the received claim may indicate various information including date of default, manner of default, cause of default, condition of property upon default, a policy number, an address, a lessee name, a lessor name, and/or other information. Upon comparing this information with stored information, the cancellation system 104d can determine whether a policy exists. The cancellation system can also update the corresponding record for this account to indicate that a claim has now been filed to begin the claim fulfillment process. Thus, when the policy number is accessed again (via a computer, telephone, and/or otherwise), information regarding the current state of the policy and the claim may be determined.

To that end, the cancellation system 104d may determine if there is any reason not to honor the claim (block 3658). This might include searching locally or remotely stored records regarding any other claims that have been filed by this lessee and/or lessor. As a nonlimiting example, if a lessee (or lessor) has filed multiple (and/or a predetermined number of) claims on other loss mitigation instruments, a claim may be denied. Similarly, if a lessee (or lessor) has filed multiple claims on an insurance policy, the claim may be denied. Similarly, if any terms of the loss mitigation instrument have been violated, the claim may be denied. Further, the cancellation system 104d might determine whether the trigger for implementing the loss mitigation instrument (e.g., lessee loses his/her job) has occurred prior to fulfilling the claim. In response to a determination that there is no reason to not honor the claim, the cancellation system 104d facilitates payment of the claim to the lessor (block 3660).

More specifically, as discussed above, if the loss mitigation system 104 determines that the claim is to be fulfilled, the administrator computing device 104c can contact an accounting (and/or claims) segment of the loss mitigation system 104, to facilitate payment of the claim.

One should note that regardless of whether the lessee and/or lessor owns the loss mitigation instrument, the claim (in at least one embodiment) will be paid to the lessor. Because of this, the lessor can allow the lessee to break the lease agreement without further repercussion. However, in at least one other embodiment, the claim payment may be made to the lessee to continue payments on the lease (and thus not violating the terms of the lease) without involving the lessor. Because the lessor will continue to receive the monthly lease payments, the lessee need not be aware that a claim has been filed.

FIG. 37 illustrates a nonlimiting example of a process for implementing a loss mitigation instrument in the case of default by a lessee. As illustrated in the nonlimiting example of FIG. 37, the lessor computing device 106 can receive an indication of a lessee inability to pay on a lease (block 3752). As discussed above, this may take the form of a user response to a user interface and/or a telephone call from the lessee and/or lessor. The lessor can instigate issuance of a summons for unlawful detainer, which is presented to the lessee (block 3754). A determination may be made regarding a loss mitigation instrument exists for this lessee and/or lessor (block 3756). If there is not loss mitigation instrument, the lessor can evict the lessee, be forced to sue the lessee for breach of contract, and/or acquire another lessee to reclaim the benefit of the lease (block 3764).

Returning to block 3756, if a loss mitigation instrument exists for this lessee and/or lessor, the lessee receives the summons, and files a claim on the loss mitigation instrument (block 3758). The underwriter 104a can process the claim to determine the amount to pay the lessor according to the loss mitigation instrument (block 3760). As discussed with regard to the nonlimiting example of FIG. 20, this might include determining whether there is any reason not to fulfill the claim. The underwriter 104a can pay the lessor according to the loss mitigation instrument and the lessee may self vacate (block 3762).

FIG. 38 illustrates a nonlimiting example of a process for implementing a loss mitigation instrument while allowing the lessee to remain in possession of the property, similar to the process from FIG. 34. As illustrated in the nonlimiting example of FIG. 38, the lessor computing device 106 can receive an indication of a lessee inability to pay a lease payment (block 3852). The lessor can instigate issuance of a summons for unlawful detainer, which is presented to the lessee (block 3854). A determination can be made regarding whether the lessee (or lessor) has a loss mitigation instrument for this lease (block 3856). If not, the lessor may be forced to litigate, pursue the lessee, or acquire another lessee to reclaim the benefit of the lease (block 3854). If however, there is a loss mitigation instrument, the system can pay the lease payment for the lessee, allowing the lessee to remain in the property (block 3858). As discussed above, prior to paying a claim, a determination regarding the validity of the claim and the occurrence of an event to (e.g., job loss or other financial hardship) to trigger payment may occur.

A determination can be made regarding whether the lessee is able to pay the next lease payment (e.g., next month—block 3860). If not the process returns to block 3858 for the cancellation system 104d to continue paying the lease payments. If however, the lessee is able to pay the next lease payment, the lessee reclaims payment on the lease until expiration of the lease payment (block 3862).

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. Further, the scope of the present disclosure is intended to cover all combinations and sub-combinations of all elements, features, and aspects discussed above. All such modifications and variations are intended to be included herein within the scope of this disclosure.

Therefore, at least the following is claimed:

1. A method for providing a loss mitigation instrument, comprising:
providing, by a computing device, an interface for a party to a lease of property to apply for a loss mitigation instrument;
receiving, by the computing device, information from the party to the lease regarding a lessee and the property;
determining, by the computing device, terms for the loss mitigation instrument based on the received information, where the loss mitigation instrument is configured to provide for payment of a claim for default on the lease by the lessee, where the default results from a predetermined cause; and
providing, by the computing device, the loss mitigation instrument to the party to the lease.

2. The method of claim 1, wherein the loss mitigation instrument indicates that in the event of default by the lessee on payment of the lease, the claim is paid directly to a lessor of the property.

3. The method of claim 1, wherein the loss mitigation instrument indicates that in the event of default by the lessee on payment of the lease, the claim is paid directly to the lessee of the property.

4. The method of claim 1, wherein the predetermined cause includes at least one of the following: loss of job, bankruptcy, death, and divorce.

5. The method of claim 1, wherein determining terms for the loss mitigation instrument includes communicating with a clearinghouse system, the clearinghouse system configured to determine probabilities of default for the lessee at the property.

6. The method of claim 1, wherein the loss mitigation instrument is configured for at least one of the following: residential property, commercial property, passenger vehicles, commercial vehicles, fleets, equipment, watercraft, and aircraft.

7. The method of claim 1, wherein the loss mitigation instrument is provided at least one of the following times:
before the lessee executes an agreement on the lease; and
after the lessee executes the agreement on the lease.

8. A loss mitigation system for providing a loss mitigation instrument, comprising:
a memory component that stores risk assessment logic that includes instructions for performing at least the following:
providing, by a computing device, an interface for a party to a lease of property to apply for a loss mitigation instrument;
receiving, by the computing device, information from the party to the lease regarding a lessee and the property;
determining, by the computing device, terms for the loss mitigation instrument based on the received information, where the loss mitigation instrument is configured to provide payment for a claim for default on the lease by the lessee, where the default results from a predetermined cause to the lessee; and
providing, by the computing device, the loss mitigation instrument to the party to the lease.

9. The loss mitigation system of claim 8, wherein the loss mitigation instrument indicates that in the event of default by the lessee on payment of the lease, the claim is paid directly to a lessor of the property.

10. The loss mitigation system of claim 8, wherein the loss mitigation instrument indicates that in the event of default by the lessee on payment of the lease, the claim is paid directly to the lessee of the property.

11. The loss mitigation system of claim 8, wherein the predetermined cause includes at least one of the following: loss of job, bankruptcy, death, and divorce.

12. The loss mitigation system of claim 8, wherein determining terms for the loss mitigation instrument includes communicating with a clearinghouse system, the clearinghouse system configured to determine probabilities of default for the lessee at the property.

13. The loss mitigation system of claim 8, wherein the loss mitigation instrument is configured for at least one of the following: residential property, commercial property, passenger vehicles, commercial vehicles, fleets, equipment, watercraft, and aircraft.

14. The loss mitigation system of claim 8, wherein providing the loss mitigation instrument to the lessee includes at least one of the following:
sending, only to the lessee, an indication of acceptance of the loss mitigation instrument;
sending, only to a lessor associated with the loss mitigation instrument, an indication of acceptance of the loss mitigation instrument; and
sending, to the lessee and the lessor, an indication of acceptance of the loss mitigation instrument.

15. A computer-readable medium for a loss mitigation system that stores risk assessment logic for performing at least the following:
providing, by a computing device, an interface for a party to a lease of property to apply for a loss mitigation instrument;
receiving, by the computing device, information from the party to the lease regarding the lessee and the property;
determining, by the computing device, terms for the loss mitigation instrument based on the received information, where the loss mitigation instrument is configured to provide for payment of a claim for default on the lease by the lessee, where the default results from a predetermined unexpected financial hardship to the lessee, as defined by the loss mitigation instrument; and
providing, by the computing device, the loss mitigation instrument to the party to the lease.

16. The computer-readable medium of claim 15, wherein the loss mitigation instrument indicates that in the event of default by the lessee on payment of the lease, the claim is paid directly to a lessor of the property.

17. The computer-readable medium of claim 15, wherein the loss mitigation instrument indicates that in the event of default by the lessee on payment of the lease, the claim is paid directly to the lessee of the property.

18. The computer-readable medium of claim 15, wherein the predetermined unexpected financial hardship includes at least one of the following: loss of job, bankruptcy, death, and divorce.

19. The computer-readable medium of claim 15, wherein determining terms for the loss mitigation instrument includes communicating with a clearinghouse system, the clearinghouse system configured to determine probabilities of default for the lessee at the property.

20. The computer readable medium of claim 15, wherein the loss mitigation instrument is configured for at least one of the following: residential property, commercial property, passenger vehicles, commercial vehicles, fleets, equipment, watercraft, and aircraft.
